(19) United States
(12) Patent Application Publication
(10) Pub. No.: US 2008/0181174 A1
(43) Pub. Date: Jul. 31, 2008

(54) METHOD AND APPARATUS FOR A TRANSCEIVER IN A MOBILE/FIXED RELAY WITH MULTIPLE ANTENNAS

(76) Inventor: YONG SOO CHO, SEOUL (KR)

Correspondence Address: IPLA P.A., 3580 WILSHIRE BLVD., 17TH FLOOR, LOS ANGELES, CA, 90010, US

(21) Appl. No.: 11/747,829

(22) Filed: May 11, 2007

(30) Foreign Application Priority Data
Jan. 25, 2007 (KR) 10-2007-0007795

(51) Int. Cl. H04B 7/00; H04B 1/38; H04J 1/00; H04J 3/00

(52) U.S. Cl. 370/329; 370/280; 370/281; 455/272; 455/73

(57) ABSTRACT

Disclosed is a method and apparatus for increasingly improving a performance of a mobile communication system or a wireless broadcasting system, such as a Cellular System, a PCS (Personal Communication Service), a WiBro, a DMB (Digital Multimedia Broadcasting) or a GPS (Global Positioning System) by installing a mobile/fixed relay having multiple antennas in mobile vehicles, such as a automobile or a bus, or in fixed structures, such as a house or a building, to achieve beam-forming gain or diversity gain.

### CROSS REFERENCE

Applicant claims foreign priority under Paris Convention and 35 U.S.C. §119 to the Korean Patent Application No. 10-2007-0007795, filed Jan. 25, 2007 with the Korean Intellectual Property Office.

### TECHNICAL FIELD

The present invention relates to a method and apparatus for increasingly improving a performance of a mobile communication system or a wireless broadcasting system, such as a Cellular System, a PCS (Personal Communication Service), a WiBro, a DMB (Digital Multimedia Broadcasting) or a GPS (Global Positioning System) by installing a mobile/fixed relay having multiple antennas in mobile vehicles, such as a automobile or a bus, or in fixed structures, such as a house or a building, to achieve beam-forming gain or diversity gain.

### BACKGROUND ART

The field of communication has been rapidly propagated from 90's up to date, due to the development of various technologies including a mobile communication system, such as a cellular system, a PCS or a WiBro, or a broadcasting system, such as a DMB, as well as a GPS. Recently, multiple antenna technologies have been developed to improve the performance of such communication system. The multiple antenna technologies can be largely classified into beam-forming method and MIMO (Multiple Input Multiple Output) method in accordance with the disposition interval of antennas and using method thereof. The beam-forming method can remove the interference signals received from adjacent cells and obtain the beam-forming gain by disposing the antennas at interval of λ/2 to form the beam in desired directions. The MIMO method can obtain the diversity gain or multiplexing gain by disposing the antennas at interval of 4λ, compared to a wireless communication system using a single antenna. The MIMO method can transmit more reliable data by applying a transceiving diversity method, such as a STC (Space Time Code) or a MRC (Maximal Ratio Combining), or clarify data transmission by applying a multiplexing method, such as a BLAST (Bell Laboratory Layered Space-Time). For applying such multiple antenna technologies, however, required is an antenna interval of λ/2 or more. Since for example a terminal is limited in its size, it is difficult to mount the multiple antennas therein.

For conventional mobile communication system, research and development has been invited to a method for removing the interferences among cells and obtaining SNR (Signal-to-Noise Ratio) gain by forming the beam using a smart antenna method in a base station. Research and development has also been invited to the MIMO method utilizing such multiple antennas in the base station and one or more of such multiple antennas in the terminal. For such terminal, however, it is difficult to mount such multiple antennas therein.

### Disclosure

### Technical Problem

It is, therefore, an object of the present invention to provide a method and apparatus for a transceiver in a mobile/fixed relay with multiple antennas for high quality of signal transmission in a mobile/wireless communication system, such as a cellular system, a PCS, a WiBro, a DMB and a GPS, that overcomes the problems with the aforementioned background art, which can obtain a beam-forming gain or a diversity gain according to mobility, channel environment and mobile communication service by installing the multiple antennas in a fixed structure, such as a vehicle, a house or a building, have a suitable mobile/fixed relay antennas disposed configuration for a mobile/wireless communication system, and simultaneously estimate cell IDs of target base station and incidence angles of target signals through cell searching in a mobile/fixed relay present in a cell boundary of the mobile communication system using a hard handover such as WiBro.

### Technical Solution

The present invention provides an apparatus for a transceiver in a mobile/fixed relay with multiple antennas, comprising a mobile/fixed relay to which a beam-forming antenna and a diversity antenna are combined so as to improve a performance of a wireless broadcasting system or a mobile communication system such as a cellular system, a PCS, a WiBro, a DMB or a GPS.

An array antenna of a multiple circular structure for multiple band may be used for the beam-forming antenna, and a dual-polarized antenna for multiple band may be used for the diversity antenna.

The present invention comprises a multiple antenna having a half wavelength in an interval of each of the antennas of the circular disposed antennas.

The circular array antenna for multiple band may be disposed by half wavelength, based on the largest carrier frequency, the smallest carrier frequency or the average frequency of the multiple band.

An antenna element of the array antenna may be provided in an omni-directional antenna having a planar vertically-polarized wave property.

The circular array antenna may be unitary with a multiplexer.

The beam-forming antenna may employ at least one of a single circular antenna, a dual circular antenna and a triple circular antenna.

In addition, the present invention provides an apparatus for a transceiver in a mobile/fixed relay with multiple antennas, which can improve a performance of mobile communication system in TDD communication system in accordance with the present invention, which comprises: an outer receiving antenna, comprising a beam-forming antenna and a diversity antenna, for receiving a signal of each mobile communication system for a downward link signal; a RF station for separating signals received from the outer receiving antenna into each mobile communication system signals and converting them into base-band signals; an A/D converter for converting the signals converted into base-band signals from analog signals into digital signals; a synchronizer for estimating and compensating synchronization from the signals converted into the digital signals; a cell searcher for searching a target base station from the signals undergoing the synchronization process; a channel estimator for estimating a channel from the signals undergoing the cell searching process; a channel correlation measurer for measuring a correlation between the beam-forming antennas from the signals undergoing the channel estimator; a channel rank measurer for measuring a channel rank between the beam-forming antennas from the signals undergoing the channel estimator; a signal to interference ratio measurer for measuring a signal ratio of the target base station to the interference station from the signals undergoing the channel estimator; a channel correlation selector for selecting whether or not using a mobile relay beam-former for a hard handover from the channel correlation value and the channel rank value; a signal to interference selector for selecting whether or not using a MRC and an interference canceller from the estimated value of signal to interference ratio, the channel correlation value and the channel rank value; a mobile relay beam-former for the hard handover used when the channel correlation value is larger than a reference channel correlation value, or the channel rank value is smaller than a reference channel rank value; the MRC used when the channel correlation value is smaller than the reference channel correlation value or the channel rank value is larger than the reference channel rank value, and the estimated value of the signal to interference ratio is larger than the value of the signal to interference ratio; the interference canceller used when the channel correlation value is smaller than the reference channel correlation value or the channel rank value is larger than the reference channel rank value, and the estimated value of the signal to interference ratio is smaller than the value of the signal to interference ratio; a demodulator for demodulating from detected signals; a modulator for modulating the demodulated signals; a D/A converter for converting the modulated signals into analog signals; and an inner antenna for transmitting the converted signals to an inner terminal.

Further, the present invention provides an apparatus for a transceiver in a mobile/fixed relay with multiple antennas, which can improve a performance of the wireless communication system in TDD communication system in accordance with the present invention, which comprises: inner receiving antenna, comprising a beam-forming antenna and a diversity antenna, for receiving signals of each wireless communication systems for downward link signals; a RF station for separating signals received from the inner receiving antenna into each communication system signals and converting them into base-band signals; an A/D converter for converting the signals converted into base-band signals from analog signals into digital signals; an equalizer for equalizing channels from the signals converted into the digital signals; a demodulator for demodulating from the signals undergoing the equalization process; a modulator for modulating from the demodulated signals; a selector for selecting whether using a mobile relay beam-former for hard handover and a MRT, or an interference canceller; a mobile relay beam-former for hard handover used in a upward link when selecting the mobile relay beam-former for hard handover from a downward link by the selector; a MRT used in the upward link when selecting the MRT from the downward link by the selector; an interference canceller used in the upward link when selecting the interference canceller from the downward link by the selector; a D/A converter for converting pre-coded signals into analogue signals through the mobile relay beam-former for hard handover, the MRT and the interference canceller; a RF station for converting into pass-band signals for the signals converted into the analogue signals; and an outer antenna for transmitting the signals converted into the pass-band signals.

Further, the present invention provides an apparatus for a transceiver in a mobile/fixed relay with multiple antennas, which can improve a performance of the mobile communication system in FDD communication system in accordance with the present invention, which comprises: an outer receiving antenna, comprising a beam-forming antenna and a diversity antenna, for receiving signals of each mobile communication systems for downward link signals; a RF station for separating signals received from the outer receiving antenna into each mobile communication system signals and converting them into base-band signals; an A/D converter for converting the signals converted into base-band signals from analog signals into digital signals; a synchronizer for estimating and compensating synchronization from the signals converted into the digital signals; a cell searcher for searching a target base station from the signals undergoing the synchronization process; a mobile/fixed relay beam-former for soft handover for forming a beam for soft handover from the signals undergoing the cell searching process; an equalizer for equalizing the beam-formed signals into an estimated signals; a demodulator for demodulating from detected signals through the equalizer; a modulator for modulating the demodulated signals; a D/A converter for converting the modulated signals into analog signals; and an inner antenna for transmitting the converted signals to an inner terminal.

Further, the present invention provides an apparatus for a transceiver in a mobile/fixed relay with multiple antennas, which can improve a performance of the mobile communication system in FDD communication system in accordance with the present invention, which comprises: an inner receiving antenna, comprising a beam-forming antenna and a diversity antenna, for receiving signals of each mobile communication systems for downward link signals; a RF station for separating signals received from the inner receiving antenna into each communication system signals and converting them into base-band signals; an A/D converter for converting the signals converted into base-band signals from analog signals into digital signals; an equalizer for equalizing channels from the signals converted into the digital signals; a demodulator for demodulating from the signals undergoing the equalization process; a modulator for modulating from the demodulated signals; a mobile/fixed relay beam-former for soft handover for pre-coding from the modulated signals; a D/A converter for converting the pre-coded signals into analogue signals through the mobile/fixed relay beam-former for soft handover; a RF station for converting into pass-band signals for the signal converted into the analogue signals; and an outer antenna for transmitting the signal converted into the pass-band signals.

Further, the present invention provides an apparatus for a transceiver in a mobile/fixed relay with multiple antennas, which can improve the performance of the wireless communication system in broadcasting communication system in accordance with the present invention, which comprises: an outer receiving antenna, comprising a beam-forming antenna and a diversity antenna, for receiving signals of each wireless communication systems; a RF station for separating signals received from the outer receiving antenna into each wireless communication system signals and converting them into base-band signals; an A/D converter for converting the signals converted into base-band signals from analog signals into digital signals; a synchronizer for estimating and compensating synchronization from the signals converted into the digital signals; a channel estimator for estimating a channel from the signals undergoing the cell searching process; a MRC or EGC for detecting a signal after the channel estimating process; a demodulator for demodulating from the detected signals; a modulator for modulating the demodulated signals; a D/A converter for converting the modulated signals into analog signals; and an inner antenna for transmitting the converted signals to an inner terminal.

When selecting the beam-former, signals of the circular array antenna, which is beam-forming antenna, may be used.

The MRC may use signals of the diversity antenna.

The MTC may use signals of the diversity antenna.

The interference canceller may use signals of the diversity antenna.

The channel correlation measurer may estimate signals received from the circular array antenna using the following math figure:

$$\begin{matrix}ρ = ( {y}_{n} , {y}_{n} ) \\ = \frac{E [ {y}_{n} {y}_{m} ] - E [ {y}_{n} ] E [ {y}_{n} ]}{\sqrt{( E [ {y}_{n}^{2} ] - {E [ {y}_{n} ]}^{2} ) ( E [ {y}_{m}^{2} ] - {E [ {y}_{m} ]}^{2} )}}\end{matrix}$$

where, yₙ is a received signal received in n^{th} antenna, yₘ is a received signal received in m^{th} antenna, and E[ ] denotes an average.

The channel correlation measurer using a channel value may use the circular array antenna, and estimate the channel correlation among antennas using the following math figure:

$$\begin{matrix}ρ = ( {H}_{n} , {H}_{n} ) \\ = \frac{E [ {H}_{n} {H}_{m} ] - E [ {H}_{n} ] E [ {H}_{n} ]}{\sqrt{( E [ {H}_{n}^{2} ] - {E [ {H}_{n} ]}^{2} ) ( E [ {H}_{m}^{2} ] - {E [ {H}_{m} ]}^{2} )}}\end{matrix}$$

where, H₀ is a channel input through n^{th} antenna, Hₘ is a channel input through m^{th} antenna, and E[ ] denotes an average.

The channel rank measurer using a channel value may use the circular array antenna, and estimate the channel rank among antennas using the following math figure:

det(Hₘₙ−λIₘₙ)=0

where, Hₙₘ is a channel input through antenna, m denotes antenna, and n denotes a tap of channel or subcarrier wave.

The signal to interference ratio measurer is:

$$• SIR = 10 {log}_{10} \{ \frac{{\sum }_{i = 0}^{N} y ( {N}_{Spacing} \times i + {N}_{offset} + {S}_{T} ) \times {P}_{T} ( i )}{{\sum }_{k = 0}^{N} \{ {\sum }_{i = 0}^{N} y ( {N}_{Spacing} \times i + {N}_{offset} + {S}_{k} ) \times {P}_{k} ( i ) \}} \}$$

where, y is a received signal, P_{T} is a preamble of target signal, Pₖ is a preamble of n^{th} interference signal, N_{spacing} is an interval between the frequencies of preamble signal, N_{Int1} is the number of interference signal, Nₚ is the number of preamble subcarrier wave, N_{offset} denotes a subcarrier offset of preamble, S_{T} is a segment of target signal, Sₖ denotes a segment of k^{th} interference signal, and a signal ratio of adjacent base station functioned with a signal and interference of target base station may be estimated using the above math figure.

The cell searcher is,

$$( C , θ ) = {max}_{c , θ} ( {a ( θ )}^{H} {R}_{c} a ( θ ) )$$

$$( C , θ ) = {max}_{c , θ} ( \frac{1}{{a ( θ )}^{H} {R}_{c}^{- 1} a ( θ )} )$$

$$( C , θ ) = {max}_{c , θ} ( \frac{1}{{a ( θ )}^{H} {( {V}_{c} )}_{n} {( {V}_{c} )}_{n}^{H} a ( θ )} )$$

where, R_{c} denotes a self-correlation matrix of inter-correlation matrix in a preamble and a receiving signal, a(↓) denotes adjusting vector for incidence angle θ, (V_{c})ₙ denotes a noise subspace vector, Cell ID(C) is a C value when a value of the each figure becomes maximum, and θ value becomes an incidence angle, and the incidence angle and the cell searching may be carried out using the above figure.

Some candidate incidence angle is estimated from the receiving signals, followed by estimating the Cell ID and the incidence angle only for the candidate incidence angle, wherein the candidate incidence angle is estimated in a first step,

$$P ( θ ) = {max}_{θ} ( {a ( θ )}^{H} Ra ( θ ) )$$

$$P ( θ ) = {max}_{θ} ( \frac{1}{{a ( θ )}^{H} {R}^{- 1} a ( θ )} )$$

$$P ( θ ) = {max}_{θ} ( \frac{1}{{a ( θ )}^{H} {V}_{n} {V}_{n}^{H} ( θ )} )$$

where, R denotes a self-correlation matrix for receiving signal, a(θ) denotes adjusting vector for incidence angle θ, M (M is a natural number) of θ value becomes a candidate incidence angle in each figures, and the Cell ID and the incidence angle are estimated in a second step using the candidate incidence angle,

$$( C , θ ) = {max}_{c , θ} ( {a ( {θ}_{m} )}^{H} {P}_{c} ) , \\ m = 0 , 1 , … , M - 1$$

where, θₘ means a candidate incidence angle estimated in the first step, M denotes the number of the candidate incidence angle, and the cell searching and the incidence angle is simultaneously estimated using the above figure.

The method estimating the Cell ID and the incidence angle, and the cell searching and the incidence angle, simultaneously, using the inter-correlation matrix of receiving signals for use includes Direct Searching, Peak Searching, and Joint Peak Searching.

The estimator of Direct Searching method is,

$$θ = a sin \{ E [ \frac{- ln ( {P}_{C}^{l} / {P}_{C}^{l - 1} )}{- j2 π d / λ} ] \}$$

where, P^{I}_{c} denotes an inter-correlation value of receiving signal and preamble signal of the Cell ID(C) in i^{th} antenna, d denotes the distance between the antennas, λ denotes wavelength, and searches θ value, while Cell ID being searched, at which the product of adjusting vector becomes maximum.

The estimator of Peak Searching method is,

$$θ = {max}_{θ} ( {a ( θ )}^{H} {P}_{C} )$$

where, P_{c} denotes an inter-correlation value of receiving signal and preamble signal of the Cell ID(C), a(θ) denotes adjusting vector, and searches θ value, while Cell ID being searched, at which the product of adjusting vector becomes maximum.

The estimator of Joint Peak Searching method is,

$$( C , θ ) = {max}_{c , θ} ( {a ( θ )}^{H} {P}_{c} )$$

where, P_{c} denotes a correlation value of receiving signal and preamble signal of the Cell ID, a(θ) denotes adjusting vector, and evaluates an inter-correlation with the receiving signal for possible Cell ID, followed by searching Cell ID and incidence angle at which the product of the adjusting vector becomes maximum.

Still Further, the present invention provides a method of transceiving for a mobile/fixed relay with multiple antennas able to improve a performance of the mobile communication system in TDD communication system in accordance with the present invention, which comprises: receiving signals of each mobile communication systems for downward link signals using a beam-forming antenna and a diversity antenna; separating the received signals into each mobile communication system signals, converting them into base-band signals, and estimating and compensating a synchronization; performing a cell searching for searching a target base station using the base-band signals; estimating a channel after the cell searching; measuring a channel correlation between the beam-forming antennas from the estimated signals in the channel, measuring a channel rank between the beam-forming antennas, and measuring a signal ratio of the target base station to the interference base station; using a mobile relay beam-former for hard handover when the channel correlation value is larger than a reference channel correlation value, or the channel rank value is smaller than a reference channel rank value, and using a MRC when the channel correlation value is smaller than a reference channel correlation value, or the channel rank value is larger than a reference channel rank value and the value measured by the signal to interference ratio is larger than that of a reference signal to interference ratio; detecting a signal using an interference canceller when the channel correlation value is smaller than a reference channel correlation value, or the channel rank value is larger than a reference channel rank value, and when the value measured by the signal to interference ratio is smaller than that of a reference signal to interference ratio; demodulating and modulating detected signals; converting the modulating signals into analogue signals; and transmitting the converted signals to an inner terminal.

Further, the present invention provides a method of transceiving for a mobile/fixed relay with multiple antennas able to improve a performance of the wireless communication system in TDD communication system in accordance with the present invention, which comprises: receiving signals of each wireless communication systems for upward link signals using a beam-forming antenna and a diversity antenna; separating the received signals into each communication system signals and converting them into base-band signals of digital type; equalizing channels from the signals converted into the digital signals; demodulating and modulating the signals undergoing the equalization process; selecting from the converted signals whether using a mobile relay beam-former for hard handover and a MRT, or an interference canceller, and coding modulated signals through any one selected from the mobile relay beam-former for hard handover, MRT, and the interference canceller; converting the coded signals into analogue signals; and converting the signals converted into the analogue signals into pass-band signals to transmit them to a base station.

Further, the present invention provides a method of transceiving for a mobile/fixed relay with multiple antennas able to improve a performance of the mobile communication system in FDD communication system in accordance with the present invention, which comprises: receiving signals of each mobile communication systems for downward link signal using a beam-forming antenna and a diversity antenna; separating the received signals into each mobile communication system signals, converting them into base-band signals, and estimating and compensating synchronization; performing a cell searching for searching a target base station from the signals undergoing the synchronization process; forming a beam for soft handover from the signals undergoing the cell searching process; estimating a channel from the beam-formed signals and equalizing the estimated signals; demodulating and modulating the equalized signals; and converting the modulated signals into analogue signals to transmit them to an inner terminal.

Further, the present invention provides a method of transceiving for a mobile/fixed relay with multiple antennas able to improve a performance of the mobile communication system in FDD communication system in accordance with the present invention, which comprises: receiving signals of each mobile communication systems for upward link signal using a beam-forming antenna and a diversity antenna; separating the received signals into each mobile communication system signals, and converting them into base-band signals; channel-equalizing the converted signals converted into the digital signals, and demodulating and modulating them; pre-coding the modulated signals; converting the pre-coded signals into analogue signals; converting the signals converted into the analogue signals into pass-band signals; and transmitting the signals converted into the pass-band signals to a base station.

Further, the present invention provides a method of transceiving for a mobile/fixed relay with multiple antennas able to improve a performance of the wireless communication system in broadcasting communication system in accordance with the present invention, which comprises: receiving signals of each wireless communication systems using a beam-forming antenna and a diversity antenna; separating the signals received from the outer receiving antenna into each wireless communication system signals and converting them into base-band signals; estimating and compensating synchronization from the signals converted into the digital signals; estimating a channel from the signals undergoing the synchronization process; detecting a signal after the channel estimating process; demodulating and modulating from the detected signals; and converting the modulated signals into analog signals to transmit them to an inner terminal.

The channel correlation measurement may estimate a signal received from the circular array antenna using the following math figure:

$$\begin{matrix}ρ = ( {y}_{n} , {y}_{n} ) \\ = \frac{E [ {y}_{n} {y}_{m} ] - E [ {y}_{n} ] E [ {y}_{n} ]}{\sqrt{( E [ {y}_{n}^{2} ] - {E [ {y}_{n} ]}^{2} ) ( E [ {y}_{m}^{2} ] - {E [ {y}_{m} ]}^{2} ]}}\end{matrix}$$

where, yₙ is a received signal received in n^{th} antenna, yₘ is a received signal received in m^{th} antenna, and E[ ] denotes an average.

The channel correlation measurement using a channel value may use the circular array antenna, and estimate the channel correlation among the antennas using the following math figure:

$$\begin{matrix}ρ = ( {H}_{n} , {H}_{n} ) \\ = \frac{E [ {H}_{n} {H}_{m} ] - E [ {H}_{n} ] E [ {H}_{n} ]}{\sqrt{( E [ {H}_{n}^{2} ] - {E [ {H}_{n} ]}^{2} ) ( E [ {H}_{m}^{2} ] - {E [ {H}_{m} ]}^{2}}}\end{matrix}$$

where, Hₙ is a channel input through n^{th} antenna, Hₘ is a channel input through m^{th} antenna, and E[ ] denotes an average.

The channel rank measurement using a channel value may use the circular array antenna, and estimate the channel rank among the antennas using the following math figure:

det(Hₘₙ−λIₘₙ)=0

where, Hₙₘ denotes a channel input through antenna, m denotes an antenna, and n denotes a tap or subcarrier wave of the channel.

The measurement of the signal to interference ratio is:

$$SIR = 10 {log}_{10} \{ \frac{{\sum }_{i = 0}^{N} y ( {N}_{Spacing} \times i + {N}_{offset} + {S}_{T} ) \times {P}_{T} ( i )}{{\sum }_{k = 0}^{N} \{ {\sum }_{i = 0}^{N} y ( {N}_{Spacing} \times i + {N}_{offset} + {S}_{k} ) \times {P}_{k} ( i ) \}} \}$$

where, y is a received signal, P_{T} is a preamble of target signal, Pₖ is a preamble of k^{th} interference signal, N_{spacing} is an interval between the frequencies of preamble signal, N_{Int1} is the number of interference signal, Nₚ is the number of preamble subcarrier wave, N_{offset} denotes a subcarrier offset of preamble, S_{T} is a segment of target signal, Sₖ denotes a segment of k^{th} interference signal, and a signal ratio of adjacent base station functioned with a signal and interference of target base station may be estimated using the above math figure.

The cell searching is,

$$( C , θ ) = {max}_{c , θ} ( {a ( θ )}^{H} {R}_{c} a ( θ ) )$$

$$( C , θ ) = {max}_{c , θ} ( \frac{1}{{a ( θ )}^{H} {R}_{c}^{- 1} a ( θ )} )$$

$$( C , θ ) = {max}_{c , θ} ( \frac{1}{{a ( θ )}^{H} {( {V}_{c} )}_{n} {( {V}_{c} )}_{n}^{H} a ( θ )} )$$

where, R_{c} denotes a self-correlation vector of inter-correlation matrix between a preamble and a receiving signal, a(θ) denotes adjusting vector for incidence angle θ, (V_{c})ₙ denotes a noise subspace vector, Cell ID(C) is a C value when a value of the each figure becomes maximum, and θ value becomes an incidence angle, and the incidence angle and the cell searching may be carried out using the above figure.

Some candidate of the incidence angle is estimated from the receiving signals, followed by estimating the Cell ID and the incidence angle only for the candidate of the incidence angle, wherein the candidate of the incidence angle is estimated in a first step,

$$P ( θ ) = {max}_{θ} ( {a ( θ )}^{H} Ra ( θ ) )$$

$$P ( θ ) = {max}_{θ} ( \frac{1}{{a ( θ )}^{H} {R}^{- 1} a ( θ )} )$$

$$P ( θ ) = {max}_{θ} ( \frac{1}{{a ( θ )}^{H} {V}_{n} {V}_{n}^{H} ( θ )} )$$

where, R denotes a self-correlation matrix for receiving signal, a(θ) denotes adjusting vector for incidence angle θ, M (M is a natural number) of θ value becomes a candidate incidence angle in each figures, and the Cell ID and the incidence angle are estimated in a second step using the candidate of the incidence angle,

$$( C , θ ) = {max}_{c , θ} ( {a ( {θ}_{m} )}^{H} {P}_{c} ) , \\ m = 0 , 1 , … , M - 1$$

where, θₘ means a candidate of the incidence angle estimated in the first step, M denotes the number of the candidate of the incidence angle, and the cell searching and the incidence angle is simultaneously estimated using the above figure.

The method estimating the Cell ID and the incidence angle, and the cell searching and the incidence angle, simultaneously, using the inter-correlation matrix of receiving signals for use includes Direct Searching, Peak Searching, and Joint Peak Searching.

The Direct Searching method is,

$$θ = asin \{ E [ \frac{ln ( {P}_{C}^{l} / {P}_{C}^{l - 1} )}{- j 2 π d / A} ] \}$$

where, P^{I}_{c} denotes an inter-correlation value of receiving signal and preamble signal of the Cell ID(C) in i^{th} antenna, d denotes the distance between the antennas, λ denotes wavelength, and searches θ value, while Cell ID being searched, at which the product of adjusting vector becomes maximum.

The Peak Searching method is,

$$θ = {max}_{θ} ( {a ( θ )}^{H} {P}_{C} )$$

where, P_{c} denotes an inter-correlation value of receiving signal and preamble signal of the Cell ID(C), a(θ) denotes adjusting vector, and searches θ value, while Cell ID being searched, at which the product of adjusting vector becomes maximum.

The Joint Peak Searching method is,

$$( C , θ ) = {max}_{c , θ} ( {a ( {θ}_{m} )}^{H} {P}_{c} )$$

where, P_{c} denotes a correlation value of receiving signal and preamble signal of the Cell ID, a(θ) denotes adjusting vector, and evaluates an inter-correlation with the receiving signal for possible Cell ID, followed by searching Cell ID and incidence angle at which the product of adjusting vector becomes maximum.

SRB beam-forming may be used in the mobile relay beam-former for hard handover.

TRB beam-forming may be used in the fixed relay beam-former for hard handover.

Cell searching and incidence angle are simultaneously estimated when the incidence angle is estimated for the mobile relay beam-forming for hard handover.

SRB beam-forming may be used in the soft handover beam-forming.

The soft handover beam-forming forms a beam toward both the target base station and the adjacent base station to combine the two signals.

### DESCRIPTION OF DRAWINGS

The above objects, and other features and advantages of the present invention will become more apparent after a reading of the following detailed description when taken in conjunction with the drawings, in which:

FIG. 1 is a view illustrating a mobile relay environment;

FIG. 2 is a view illustrating a fixed relay environment;

FIG. 3 is a view illustrating an automobile as an example of antenna configuration of relay system having a multiple antenna suggested in the present embodiment;

FIG. 4 is a view illustrating a whole configuration of relay system having a multiple antenna suggested in the present embodiment;

FIGS. 5a to 5c are configuration diagram of RF station of beam-forming antenna in the whole configuration diagram of relay system having a multiple antenna suggested in the present embodiments;

FIG. 6 is a view illustrating a signal processor of TDD communication system when applying a mobile relay having a multiple antenna to a mobile vehicle;

FIG. 7 is a view illustrating a signal processor of TDD communication system when applying a fixed relay having a multiple antenna to an immobile house or building;

FIG. 8 is a view illustrating a signal processor of FDD communication system when applying a relay having a multiple antenna to a mobile vehicle, a house, a building, and the like;

FIG. 9 is a configuration diagram of RF station of a diversity antenna in the whole configuration diagram of relay system having a multiple antenna suggested in the present invention;

FIG. 10 is a view illustrating a signal processor of DMB or GPS system in a mobile/fixed relay having a multiple antenna;

FIG. 11 is a view illustrating a method for estimating an incidence angle after cell searching in a mobile/fixed relay having a multiple antenna;

FIG. 12 is a view illustrating a method for cell-searching after estimating an incidence angle in a mobile/fixed relay having a multiple antenna;

FIG. 13 is a view illustrating a method for simultaneously cell-searching and estimating an incidence angle in a mobile/fixed relay having a multiple antenna;

FIG. 14 is a view illustrating a first way in case of simultaneously searching a cell and estimating an incidence angle;

FIG. 15 is a view illustrating a second way in case of simultaneously searching a cell and estimating an incidence angel;

FIG. 16 is a view illustrating a third way in case of simultaneously searching a cell and estimating an incidence angel;

FIG. 17 illustrates a beam-forming gain in a specular channel and a diversity gain in a scattering channel;

FIG. 18 illustrates a beam pattern to which a beam-forming method based on SRB is applied;

FIG. 19 illustrates results in which an incidence angle for a target signal is estimated;

FIG. 20 illustrates a BER performance to which a beam-forming method based on TRB is applied;

FIG. 21 illustrates a BER performance to which a beam-forming method based on SRB is applied;

FIG. 22 illustrates a BER performance in accordance with a position of relay in a cell when applying a MRC method thereto using a diversity antenna in a scattering channel; and

FIG. 23 illustrates a BER performance in accordance with a position of relay in a cell when applying an interference cancellation method thereto using a diversity antenna in a scattering channel.

### BEST MODE

Hereinbelow, preferred embodiments will be further described in detail with reference to the accompanying drawings. Although specific terms or words are employed herein, they are used in a generic and descriptive sense only in conformity for the technical spirits of the invention and not for limiting purposes of ordinary or dictionary meaning. It should be appreciated that modifications or changes could be made to the embodiments described hereinbelow without departing from the inventive concepts thereof It should be understood, therefore, that this invention is not limited to the particular embodiments disclosed herein, but it is intended to cover modifications or changes within the spirit and scope of the present invention as defined by the appended claims. Accordingly, plural instances may be provided for components described herein as a single instance.

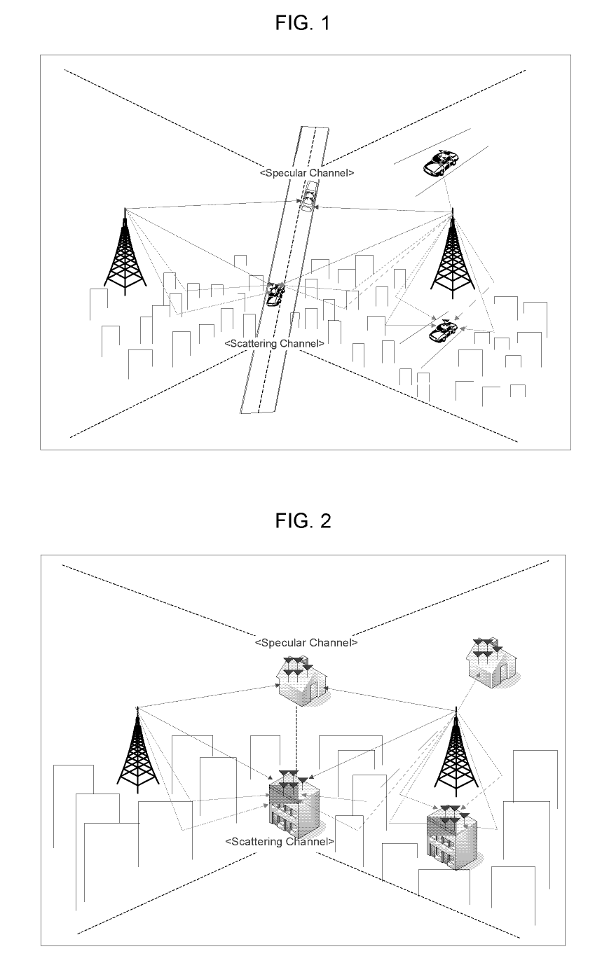

FIG. 1 illustrates a mobile relay in which relay is installed in the mobile vehicles, which requires other transceiving type according to a channel environment, a position of relay in a cell, and a type of mobile/wireless communication.

First, the channel can be largely classified into a specular channel and a scattering channel according to its environment.

The specular channel means a channel environment free of signal scattering, due to the presence of LoS (Line-of-Sight), and the absence of reflector. Beam-forming method is suitable for the specular channel, since high correlation between the antennas enables a space-division. The scattering channel means a channel environment, in which the scattering of transceiving signals is present due to the presence of the reflector between the base station and the relay. Diversity method is suitable for the scattering channel, since it can undergo an independent fading and has a little correlation between the antennas to thereby advantageously overcome the fading and obtain the diversity gain.

Second, the relay can be divided into that present in a cell and that present in a cell boundary. When the relay is in the cell, the interference of signals from adjacent base stations functions decreasingly, and when the relay is in the cell boundary, the interference of signals from adjacent base stations functions increasingly.

Third, the system can be classified into a hard handover system and a soft handover system according to its type of handover.

For system using the hard handover type such as WiBro, the interference signal should be removed or cancelled, since the signal of adjacent base station functions as the interference signal in the cell boundary. In this regard, the receiving signal should be divided into the signal of the adjacent base station and the signal of the target base station. The system using the soft handover such as CDMA is, however, combines the two signals to use in the cell boundary, whereby it needs not to divide the signal of the adjacent base station and the signal of the target base station.

Fourth, the relay can be divided into according to a duplex type of the mobile communication system.

For TDD type such as WiBro, the channels of downward link and upward link are symmetric, such that the channels of the downward link and the upward link have similar values. Thus, a weighting value of the beam-forming method of downward link, the MRC method, or the interference cancellation method may be used in the upward link. For FDD type such as CDMA, however, the channels of downward link and upward link are asymmetric, such that the channels of the downward link and the upward link become different channels. Thus, a weighting value of the downward link may not be used in the upward link. However, since the variation of the incidence angle in the downward link signal and the upward link signal is small, the beam-forming method can be applied to the upward link by estimating the incidence angle of the downward link signal.

FIG. 2 illustrates a fixed relay in which a relay is installed in a fixed structure such as a house or a building, which requires other transceiving type according to a channel environment, a position of relay in a cell, and a wireless communication type, likewise the mobile relay given in FIG. 1.

The relay can be classified into the specular channel and the scattering channel according to its channel environment, an inner part of the cell and the cell boundary according to its position in which the relay exists, the hard handover and the soft handover according to its type of handover, and the symmetric channel and the asymmetric channel according to its duplex type of TDD and FDD.

In the mobile communication system using FDD duplex type, however, both the mobile relay and the fixed relay become symmetric channels, such that a multiple antenna transmitting method, which requires the channel information in transmitting the upward link such as MRT method, may not be used. In such case, the beam-forming method which does not require the channel information is suitable for the mobile/fixed relay, and the estimation of the incidence angle (Direction of Arrival; DoA) of the signal of the downward link is applied to the beam-forming method of the upward link. For the fixed relay, since there is no variation of the incidence angle as time goes by, relatively long beam-forming method may be used, but in case of the mobile relay having mobility, since the incidence angle varies with time, the beam-forming method in view of the above is needed.

For the system using the hard handover type, the interference signals received from the adjacent base station must be removed from the mobile relay or the fixed relay existing in the cell boundary, thereby requiring a method for estimating the Cell ID of the target base station and the incidence angle of the target base station from the signals received in the mobile/fixed relay.

For the system using the soft handover, since the mobile relay or the fixed relay existing in the cell boundary combines the two signals to use, and thus there is no need to divide the signals of the adjacent base station and the signals of the target base station.

The present embodiment provides a position of the relay in such a channel environment and a cell, a method and apparatus for transceiving an optimal mobile/fixed relay in view of the wireless communication system type, a multiple antenna array configuration, and a method and apparatus for simultaneously estimating the cell searching and the incidence angle in the mobile/fixed relay.

The multiple antenna technology can be applied easily to a mobile vehicle or a fixed structure, since the mobile vehicle, such as an automobile or a bus, or the fixed structure, such as a house or a building, has a little spatial constraint compared to a terminal. The present embodiment is a transceiving technology to obtain the beam-forming gain or the diversity gain by installing the mobile/fixed relay having the multiple antennas in the mobile vehicle, such as an automobile or a bus, or the fixed structure, such as a house or a building.

The present embodiment can increasingly improve a reliability of a data transmission by installing the mobile/fixed relay having the multiple antennas in the mobile vehicle, such as an automobile or a bus, or the fixed structure, such as a house or a building. Thus, when the multiple antennas are applied to such a mobile/fixed relay, the configuration of antenna and the type of transmitting/receiving varies greatly according to a carrier frequency of the wireless communication system, a duplex type, a handover type, a position of the mobile/relay (inner part of cell, cell boundary), and a channel environment. Therefore, the present embodiment suggests a method and an apparatus for a transceiver of the optimized mobile/fixed relay, in view of a carrier frequency, duplex type, handover type, position of the mobile/fixed relay, and channel environment used in the wireless communication service including a cellular system, PCS, WiBro, DMB, GPS, and the like.

In addition, the present embodiment suggests the configuration of antenna array suitable for data transceiving in the relay system, in view of the characteristic of such wireless communication service. Further, suggested is an antenna configuration for the mobile/fixed relay, since the antenna configuration for obtaining an optimal performance varies according to the characteristics of the wireless communication service in the relay system having the multiple antennas.

Further, in the mobile communication system using the hard handover such as WiBro, the signal of the adjacent base station functions as interference against the signal of the target base station, compared to CDMA system using the soft handover. Therefore, in the mobile/fixed relay existing in the cell boundary, the target signal and the interference signal should be divided through the cell searching process, and the interference signal should be removed by using the beam-forming method or the interference cancellation method. The incidence angle of the target signal should be known to apply the beam-forming method thereto. In the mobile/fixed relay, considered can be a method for estimating the incidence angle after completing the cell searching, and a method for cell searching after estimating the incidence angle. Such methods, however, have drawbacks in that the estimation spends a lot of time, since the cell searching and the estimation of the incidence angle are carried out separately, and, accordingly, a method and an apparatus for simultaneously performing the cell searching and the estimation of the incidence angle of the target signals are suggested.

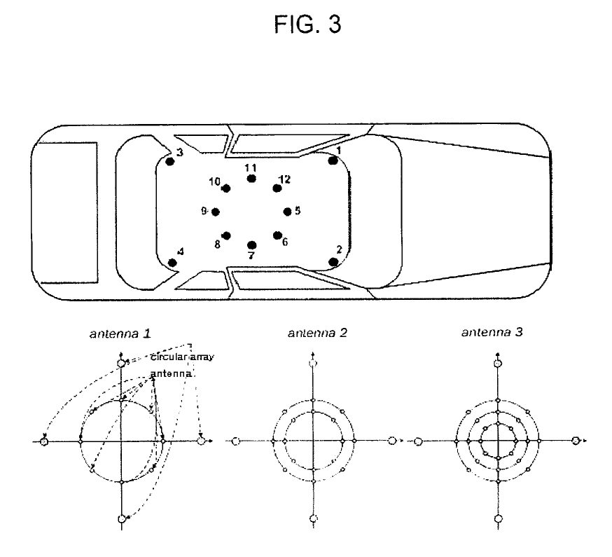

FIG. 3 illustrates an antenna array configuration of the relay system suggested in the present embodiment, comprising the beam-forming antenna and the diversity antenna.

As shown in FIG. 3, the mobile/fixed relay transceiver comprises the beam-forming antenna able to obtain the beam-forming gain, the diversity antenna able to obtain the diversity gain. As the beam-forming antenna, three of a single circular antenna, a dual circular antenna, and a triple circular antenna are provided in the present embodiment.

The single circular antenna can be operated in a cellular system in which the carrier frequency is 800 MHz, a PCS of 1,800 MHz and a WiBro of 2.3 GHz. In this case, the interval between the beam-forming antennas can be adjusted to a half wavelength of an average carrier frequency of the three systems (interval of antennas: 9.18 cm, diameter: 23.38 cm), and adjusted to the half wavelength of the carrier frequency of the system to be intended to achieve a most excellent performance (for cellular system, interval of antennas: 18.75 cm, diameter: 47.74 cm; for PCS, interval of antenna: 8.33 cm, diameter: 21.2 cm; for WiBro, interval of antenna: 6.52 cm, diameter: 16.6 cm).

The dual circular antenna comprises an outer circular array antenna operated in cellular system, and an inner circular antenna operated in PCS and WiBro. In this case, the interval between the outer circular array antennas can be adjusted to a half wavelength of a carrier frequency of the cellular system (interval of antennas: 18.75 cm, diameter: 47.74 cm), the interval between the inner circular array antennas can be adjusted to a half wavelength of an average carrier frequency of the PCS and the WiBro (interval of antennas: 7.32 cm, diameter: 18.64 cm), and adjusted to the half wavelength of the carrier frequency of the system to be intended to achieve an excellent performance of the two (for PCS, interval of antennas: 8.33 cm, diameter: 21.2 cm; for WiBro, interval of antenna: 6.52 cm, diameter: 16.6 cm).

The triple circular antenna comprises an outer circular array antenna operated in cellular system, a middle circular array antenna operated in PCS and an inner circular array antenna operated in WiBro. In this case, the interval between the each antennas can be adjusted to a half wavelength of a carrier frequency of the each system (for cellular system, interval of antennas: 18.75 cm, diameter: 47.74 cm; for PCS, interval of antennas: 8.33 cm, diameter: 21.2 cm; for WiBro, interval of antennas: 6.52 cm, diameter: 16.6 cm).

Practically, the mobile/fixed relay transceiver uses any one selected from the above three antennas, in view of the installation cost and the performance of the antenna and the RF.

In addition, the diversity antennas are spaced apart by several times the frequency to obtain a sufficient diversity gain regardless of the mobile communication system to be intended to apply. The multiple band dual polarization characteristic is so obtained by the diversity antenna that the diversity characteristic can be improved.

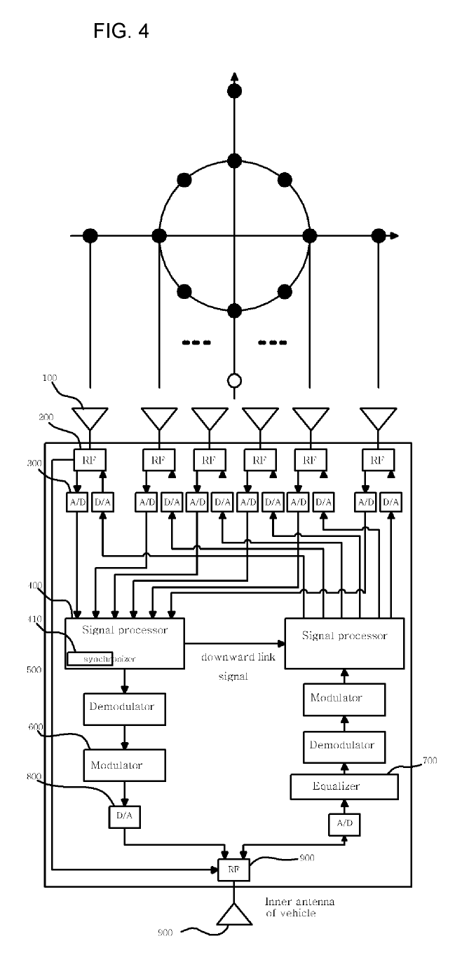

FIG. 4 illustrates the whole configuration diagram for the relay system provided in the present embodiment.

As shown in FIG. 4, in the mobile/fixed relay system having the multiple antennas suggested in the present embodiment, the signals received through the beam-forming antenna 100 and the diversity antenna 110 are transmitted again to the terminal of the vehicle or the terminal inside house or building through the inner antenna 1000 via RF (Radio Frequency) station 200, A/D converter 300, signal processor 400, demodulator 500, modulator 600, D/A converter 700 and RF station 900.

The signals received in the each antennas 100 and 110 are converted from the pass-band signals through the RF station 200 to the base-band signals. The RF station 200 has largely three array configurations according to the configuration of the aforementioned circular array antenna.

The signal processor 400 of FIG. 4 has different processing type according to a duplex type of the communication system, a correlation degree of the channel, a channel rank, a signal to interference ratio (SIR) and mobility.

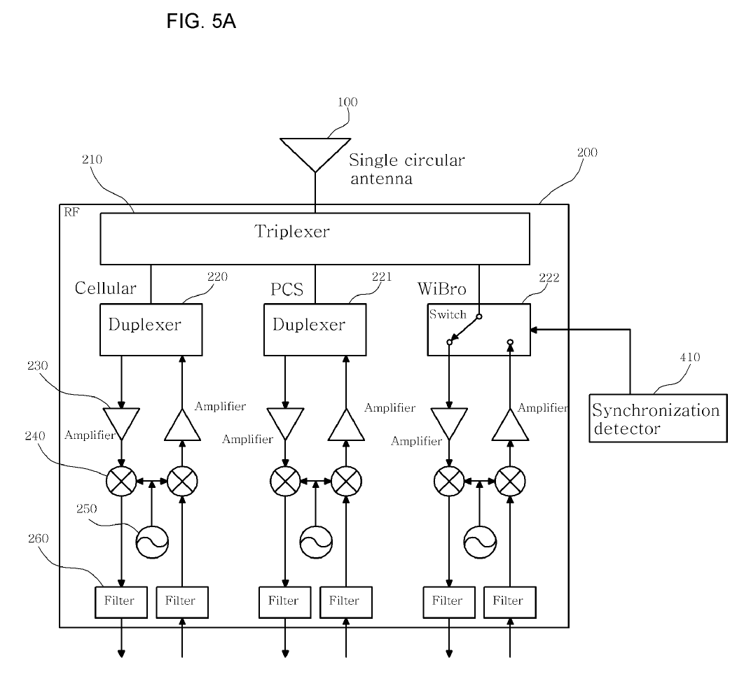

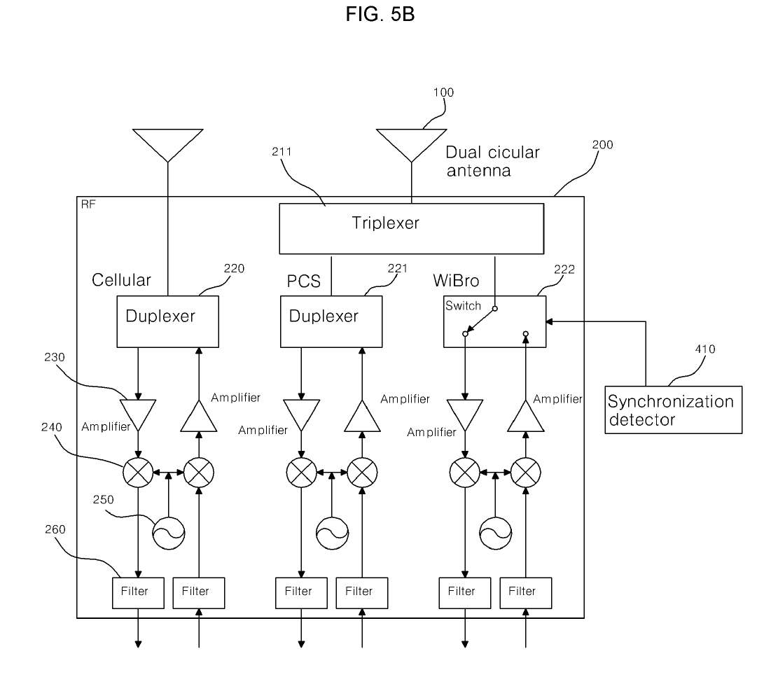

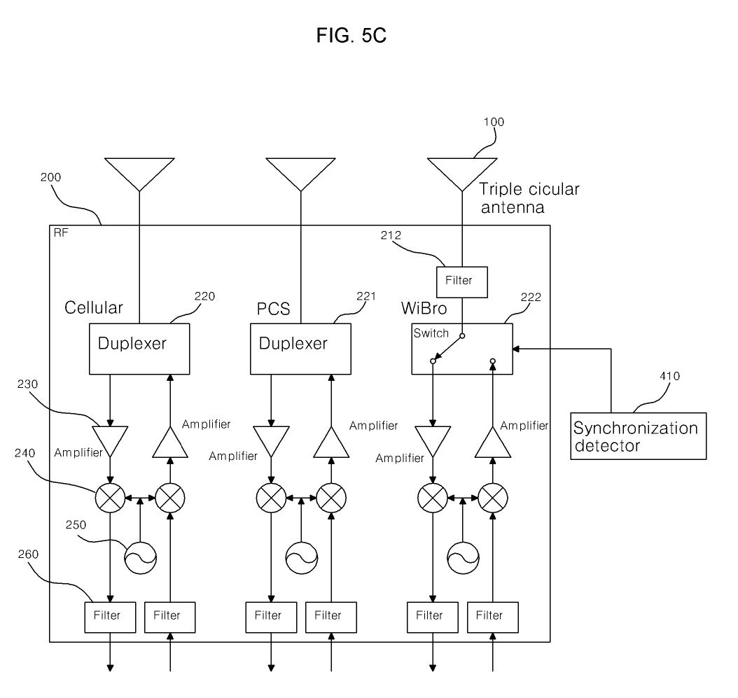

FIGS. 5a to 5c illustrate a configuration diagram of the RF station in the beam-forming antenna.

As shown in FIG. 5a, when the beam-forming antenna is a single circular antenna, it should be operated in the three mobile communication systems of the cellular system, PCS and WiBro, and, therefore, it is first divided into three frequencies through the triplexer 210.

In this case, the upward link signals and the downward link signals should be divided, since the cellular and the PCS employ the FDD type. Therefore, the signals are divided into the upward link signals and the downward link signals through the duplexers 220 and 221. The downward link signals are converted into the base-band signals through an oscillator 250 after undergoing an amplifier 230, and then the signals converted into the base-band signals are divided into more precise signals through a filter 260.

Although since the carrier frequency of the upward link and that of the downward link is same due to the usage of the TDD type, the frequency division is not required, the upward link signals and the downward link signals must be timely divided. Therefore, the WiBro receives switching signals through a synchronization detector 410 of the signal processor 400 to divide the upward link signals and the downward link signals. And then they are converted through the oscillator 250 after passing the amplifier 230 to the base-band signals. The signals converted into the base-band signals are divided into more precise signals through the filter 260.

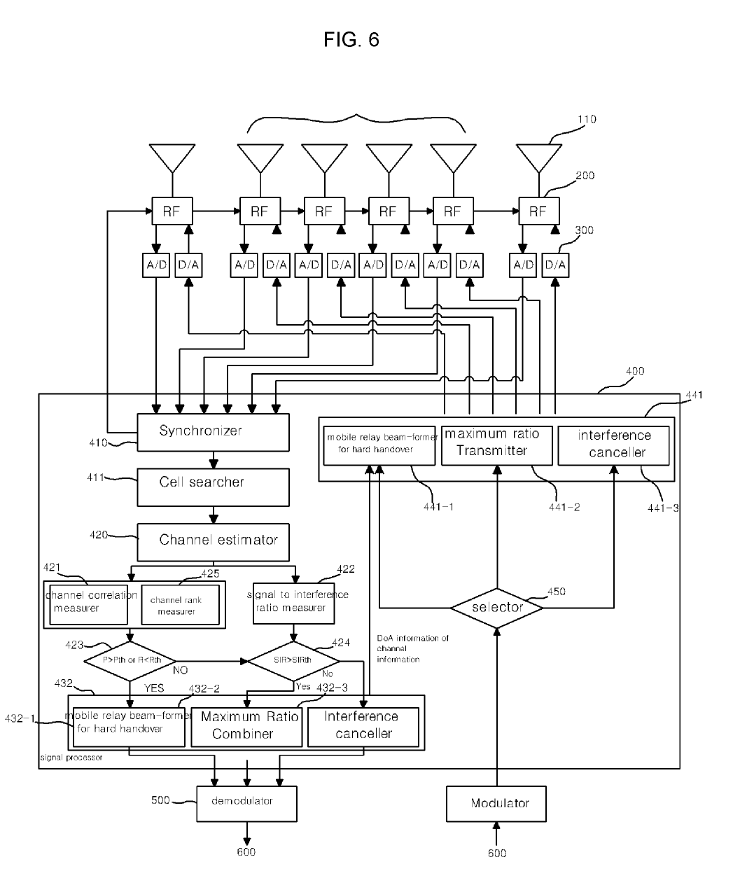

FIG. 6 illustrates a signal processor 400 in TDD communication system when employing a relay in a mobile vehicle.

After RF station 200 functions as converting a received signal through multiple antennas into a base band signal, as shown in FIG. 6, a synchronizer 410 of a signal processor 400 can take a synchronization signal, and also a cell searcher 411 can search a cell at which a relay is positioned. Then, a signal which is successively passed through a channel correlation measurer 421, a channel rank measurer 425, and a signal to interference ratio measurer 422 is selectively received from one of mobile relay beam-former for hard handover 432-1, MRC 432-2, and an interference canceller 423-3. This is because mobile relay beam-forming method for hard handover 432-1 and an interference cancellation method 423-3 make a hard handover generation in TDD communication system. When a mobile relay exists in a cell boundary in TDD communication system which uses a hard handover such as a WiBro, a signal generated from adjacent base station acts as a noise. Therefore, a receiving system and a transmitting system are selectively varied depending on the situation of a channel in order to give rise to have the deterioration of its performance.

A channel correlation measurer 421 functions as measuring the range of a channel correlation at each of antennas. The use of a beam-forming antenna 100 to be arranged every about λ/2 distance makes a channel correlation measurement in the channel correlation measurer 421. In addition, a channel rank measurer 425 functions as measuring a channel rank in an antenna spacing due to the use of beam-forming antenna 100 to be arranged by about λ/2 distance. Depending on the results of the channel correlation and the channel rank a diversity antenna 110 or a beam-forming antenna 100 is selected. Namely, this makes the selection of the beam-forming antenna 100 in the case that the value of a measured channel correlation is larger than that of a base channel correlation or that the value of a measured channel rank is smaller than that of a base channel rank. Further, the selection of the diversity antenna 110 is made in the case that the value of a channel correlation is smaller than that of a base channel correlation or that the value of a channel rank is larger than that of a base channel rank. When the value of a measured channel correlation is larger than that of a base channel correlation or that the value of a measured channel rank is smaller than that of a base channel rank, a mobile relay beam-forming method for hard handover is selected. This means that the environment is the speculator environment in such which a beam-forming method is adaptable to, so to form a beam only to a target base station, and to form a null-beam only to a next base station. Therefore, the use of a beam forming method for hard handover can make a reduction on an interference influence. Moreover, a mobile relay makes a variety of an incidence in accordance with the movement of a relay and so this case is adaptable to a SRB beam forming method more than a TRB beam forming method which requires the enough convergent hour.

Because the SRB beam forming method is a method which makes a beam-forming using the information of an incidence angle of a signal to be received, the incidence angle have to be estimated through the estimated algorithm of the incidence angle in order to utilize in a SRB beam-forming. Together with the way in which the incidence angle is estimated after a target base station is distinguished through cell searching for the estimation of the incidence angle at a mobile relay, it's possible to consider the way to be distinguished a target base station through cell searching. But there is a weakness by which time is required much for carrying out these ways.

Accordingly, the present invention is to provide a method in which the cell searching and the incidence angle estimation is simultaneously carried out. The way to be simultaneously carried out with the cell searching and the incidence angle estimation is a method in which the incidence angle is estimated together, using a preamble signal and the value of a inter-correlation and this method is conversantly described later.

The use of a MRC method or an interference cancellation method can employ in the case that the value of a channel correlation is smaller than that of a base channel correlation or that the value of a channel rank is larger than that of a base channel rank. Herein, the MRC method which can obtain a diversity gain, using a channel information measured at a receiving station is adaptable to the case that the value of a channel correlation measured by the channel correlation measurer 421 is smaller than that of a base channel correlation, or that the value of a channel rank measured by a channel rank measurer 425 is larger than that of a base channel rank, and that the value of a signal-to-noise ratio measured by a signal to interference ratio measurer 422 is larger than that of a base signal-to-noise ratio.

When the value of a channel correlation is smaller than that of a base channel correlation and the value of a channel rank is larger than that of a base channel rank, it means that a channel formed between a base station and a relay is a scattering channel. Further, the relay exists enough to adjacently be in a base station and therefore appearing a little influence on an interference signal.

It is possible to apply a Zero Forcing method, a Minimum Mean-Square Error method, and a Maximum Likelihood method to an interference cancellation method by a joint detection method which removes the interference signal generated from the next cell with the weighting value which uses channel information measured at a receiving station.

Such interference cancellation method is also applied to when the value of a channel correlation measured by the channel correlation measurer 421 is smaller than that of a base channel correlation or the value of a channel rank measured by a channel rank measurer 425 is larger than that of a base channel rank, and when the value of a signal-to-noise ratio measured by a signal to interference ratio measurer 422 is smaller than that of a base signal-to-noise ratio.

At this time, a relay is far from a base station in the case that value of a measured signal-to-noise ratio is smaller than that of a base signal-to-noise ratio and it exists in a cell boundary area separately, therefore the interference signal from the next cell is influential, and it is shown to act on it.

In case of an upward link in TDD system capable of moving, a mobile relay beam-forming method 441-1 for hard handover or a Maximum Ratio Transmitter method 442-1, and interference cancellation method 441-3 may be employed using channel information at a downward link or an incidence angle information. This is selected by a selector 450 of FIG. 6 and at this time a selectable condition is the measured value of the channel correlation measured at the downward link, the measured value of a channel rank, and the measured value of a signal-to-noise ratio.

Like the downward link, a mobile relay beam forming method 441-1 in a SRB base may be utilized when the value of a channel correlation is larger than that of a base channel correlation or the value of a channel rank is smaller than that of a base channel rank. A MRT method 441-2 may be utilized when the value of a channel correlation measured by the downward link is smaller than that of a base channel correlation or the value of a channel rank is larger than that of a base channel rank, and when the value of a signal-to-noise ratio is smaller than that of a base signal-to-noise ratio. For a channel cancellation method 441-3, it may be applied to that the measured value of a channel correlation is smaller than that of a base channel correlation or the measured value of a channel rank is larger than that of a base channel rank, and that the value of a signal-to-noise ratio is smaller than that of a base signal-to-noise ratio.

As shown in FIG. 5b, a cellular system can use an outer circular antenna if a beam-forming antenna is a dual circular antenna and PCS and WiBro can use an inner circular antenna. Because the cellular system is FDD communication system, a signal received through the outer circular antenna has to be distinguished from a downward link signal and an upward link signal. Accordingly, a signal processed by a duplexer 220 also is distinguished from a downward link signal and an upward link signal.

After passing through an amplifier 230, a downward link signal is converted into a base band signal by an oscillator 250. The converted base band signal is distinguished from more precise signal by a filter 260.

Because an inner circular antenna can be employed in a PCS system like a WiBro system, a duplexer 221 functions as distinguishing PCS WiBro signals from a received signal. Also, a downward link signal and an upward link signal have to be distinguished because of FDD communication system in PCS system, and therefore the downward link signal is distinguished from the upward link signal by duplexer 221.

After passing through an amplifier 230, a downward link signal is converted into a base band signal by an oscillator 250. The converted base band signal is distinguished from more precise signal by a filter 260.

Because of TDD communication system in WiBro system, carrier frequency of an upward link is the same of a downward link, and so it is not herein necessary that distinguish about the frequency of upward and downward link signals is made. But, the upward link signal has to be distinguished from the downward link signal in a time area. Then, a synchronization detector 410 at a signal processor 400 is distinguished from upward and downward link signals in WiBro system after the receipt of a switching signal. After passing through an amplifier 230, a downward link signal is converted into a base band signal by an oscillator 250. The converted base band signal is distinguished from more precise signal by a filter 260.

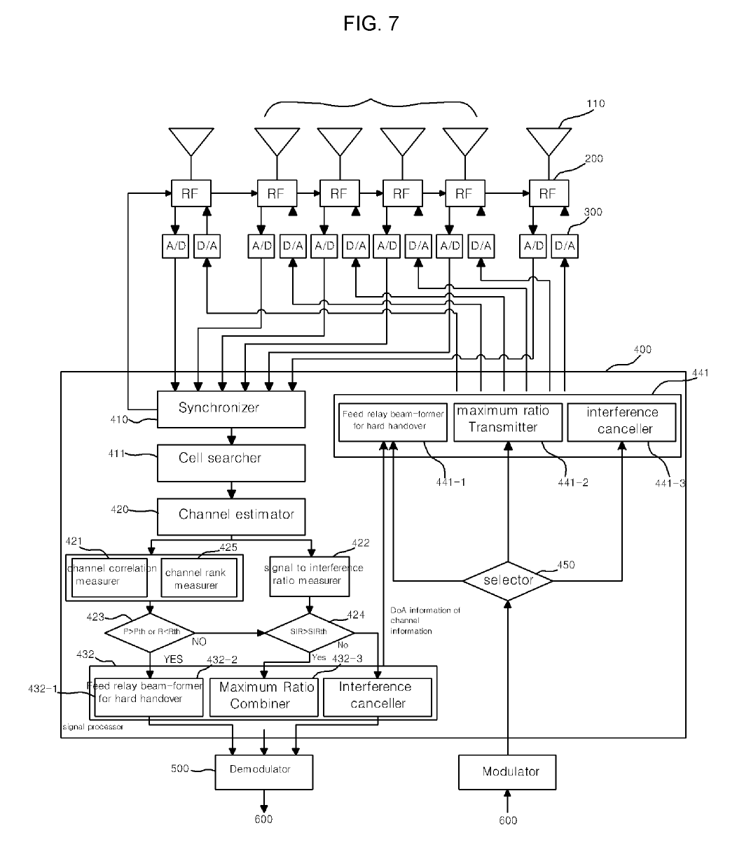

FIG. 7 illustrates a signal processor 400 in a TDD communication system when a relay having a multiple antenna is applied to a fixed building free of mobility.

In FIG. 7, a received signal from antennas 100 and 110 is converted into a base band signal by a RF station 200 and then is signal-synchronized by a synchronization detector 410 in a signal processor 400. After searching a cell where a relay located together, one of a fixed relay beam-former for hard handover 432-1, MRC 432-2, a channel canceller 432-3 may be selected by a channel correlation measurer 421, a channel rank measurer 425, and a signal to interference ratio measurer 422. The reason which use fixed relay beam forming method 432-1 and a channel cancellation method 432-3 is because a hard handover can be carried out in TDD communication system free of mobility, and therefore degrading the performance.

Like FIG. 6, channel correlation measurer 421 is an apparatus which measures a correlation degree of the channel between each antenna and functions as measuring a channel rank between each antenna using a beam-forming antenna 100. Further, channel correlation measurer 421 makes the selection of beam-forming antenna 100 in the case that the measured value of a channel correlation is larger than that of a base channel correlation or the measured value of a channel rank is smaller than that of a base channel rank and also makes the selection of a diversity antenna in the case that the measured value of a channel correlation is smaller than that of a base channel correlation or the measured value of a channel rank is larger than that of a base channel rank.

When the measured value of a channel correlation is larger than that of a base channel correlation or the measured value of a channel rank is smaller than that of a base channel rank, a fixed relay beam-former for a hard handover may be employed in a signal processor. This means that a specular channel environment is between a base station and a relay and therefore a beam-forming is made only to a target base station by using TRB beam forming method in the specular channel, so it can be reduced that an influence acts on an interference by forming a null-beam only to the next base station. Because TRB beam forming method is a method which forms a beam using a training signal of the target base station, the training signal of the target base station has to be understood in order to use a TRB beam-forming. Further, enough training signal should exist in using TRB beam-forming but the incidence angle depends on time by a fixed relay, and there are no big changes, so it is possible to do beam-forming by using the training signal for enough time.

Like a mobile relay in a TDD communication system of FIG. 6, MRC method or an interference cancellation method may be employed when the measured value of a channel correlation is larger than that of a base channel correlation or the measured value of a channel rank is smaller than that of a base channel rank. MRC method may be employed, as a method which can obtain a diversity gain by using the measured value, when the measured value of a channel correlation by channel correlation measurer 421 is smaller than that of a base channel correlation or the measured value of a channel rank by a channel rank measurer 425 is larger than that of a base channel rank, and when the value of a signal-to-noise ratio by a signal to interference ratio measurer 422 is larger than that of a base signal-to-noise ratio. The interference cancellation method may be employed when the measured value of a channel correlation by channel correlation measurer 421 is smaller than that of a base channel correlation or the measured value of a channel rank by a channel rank measurer 425 is larger than that of a base channel rank, and when the value of a signal-to-noise ratio by a signal to interference ratio measurer 422 is smaller than that of a base signal-to-noise ratio, and may be applied to ZF, MMSE, and ML method as a joint detection method at a receiving station.

In case of upward link in a TDD communication system free of mobility, a mobile relay beam-forming method 441-1 for hard handover or a Maximum Ratio Transmitter method 441-2, and interference cancellation method 441-3 may be employed by using channel information of a downward link and a beam-forming information.

This is determined by a selector 450, and the selection condition is the measured value of a channel correlation, the measured value of a channel rank, and the measured value of a signal-to-noise ratio in a downward link.

The mobile relay beam-forming method 441-1 of a TRB base may be employed when the measured value of a channel correlation is larger than that of a base channel correlation or the measured value of a channel rank is smaller than that of a base channel rank, and MRT method 441-2 may be employed when the measured value of a channel correlation in the downward link is smaller than that of a base channel correlation or the measured value of a channel rank is larger than that of a base channel rank, and when the measured value of a signal-to-noise ratio is larger than that of a base signal-to-noise ratio. The interference cancellation method 441-3 may be employed when the measured value of a channel correlation in the downward link is smaller than that of a base channel correlation or the measured value of a channel rank is larger than that of a base channel rank, and when the measured value of a signal-to-noise ratio is smaller than that of a base signal-to-noise ratio.

As shown in FIG. 5c, a cellular system can use an outer antenna when a beam-forming antenna is an outer circular antenna and a central circular antenna may be employed in a PCS system. Further, an inner circular antenna may be employed in a WiBro system. Because of FDD communication system in cellular and PCS systems, a signal received through each outer and central circular antenna has to be distinguished from the downward and upward link signals. Therefore, the downward link signal is distinguished from upward link signal by duplexers 220 and 221.

After passing through an amplifier 230, a downward link signal is converted into a base band signal by an oscillator 250. The converted base band signal is distinguished from more precise signal by a filter 260.

A WiBro system may employ the inner circular antenna. Because of TDD communication system in a WiBro system, a carrier frequency of an upward link is the same of a downward link, and so it is not herein necessary that distinguish about the frequency of upward and downward link signals is made. But, the upward link signal has to be distinguished from the downward link signal in a time area. Then, a synchronization detector 410 at a signal processor 400 is distinguished from upward and downward link signals in WiBro system after the receipt of a switching signal. After passing through an amplifier 230, a downward link signal is converted into a base band signal by an oscillator 250. The converted base band signal is distinguished from more precise signal by a filter 260.

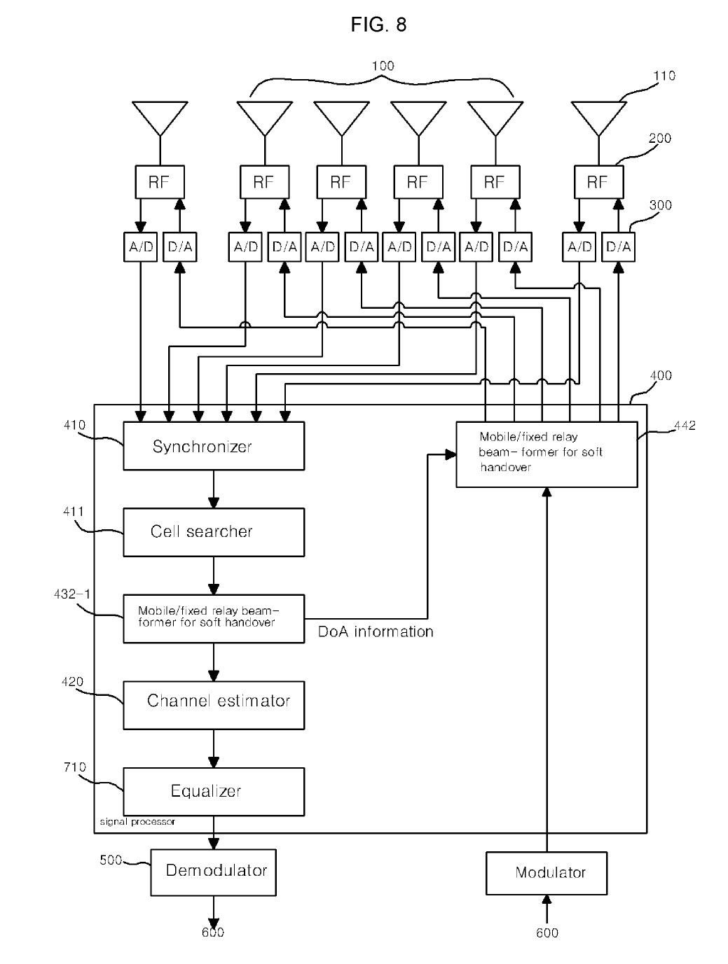

FIG. 8 illustrates a signal processor 400 in a FDD communication system when a relay is applied to a fixed building such as a mobile vehicle, house, building free of mobility.

As shown in FIG. 8, a received signal from antenna 100 is converted into a base band signal by a RF station 200 and then is signal-synchronized by a synchronization detector 410 in a signal processor 400. After searching a cell where a relay located together, a mobile/fixed relay beam-former for soft handover 432-1 is carried out through the beam-forming antenna. Using pilot signal channel estimation can be carried out. Also, equalization is carried out by an estimated channel estimated at equalization 710.

A downward link channel is different from an upward link channel in case of FDD communication system, but because a beam is formed by using the result of incidence estimation after carrying out the incidence estimation to a received signal in case of a fixed relay beam-former for soft handover. The weighting value of fixed relay beam-former at downward link can be used regardless of a channel change in downward and upward links. Accordingly, a beam is formed in the upward link by using the incidence angle of the corresponding base station estimated at the upward link.

Because the downward link channel is different from the upward link channel in case of FDD communication system, the upward link has no quality capable of using channel information in the downward link. Therefore, TRB beam forming method, MRC method, and the interference cancellation method can be not used in FDD communication system. However, because there are almost no changes compared with a channel change in view of the incidence angles of downward and upward links a mobile/fixed relay beam forming method for soft handover which to use the incidence angle information may be adaptable to SRB beam forming method. On such reason, FDD communication system may use only a beam antenna instead of a diversity antenna. To classify this in FIG. 8, an antenna not to be used is expressed as dotted lines. Further, carrying out the soft handover does not make a signal received from the next base station be functioned as an interference signal differently from carrying out a hard handover. Therefore it is not necessary to estimate a cell ID at a target and next base station, so a beam may be formed by estimating only incidence angles in the signals to be received and therefore it is possible to improve the performance.

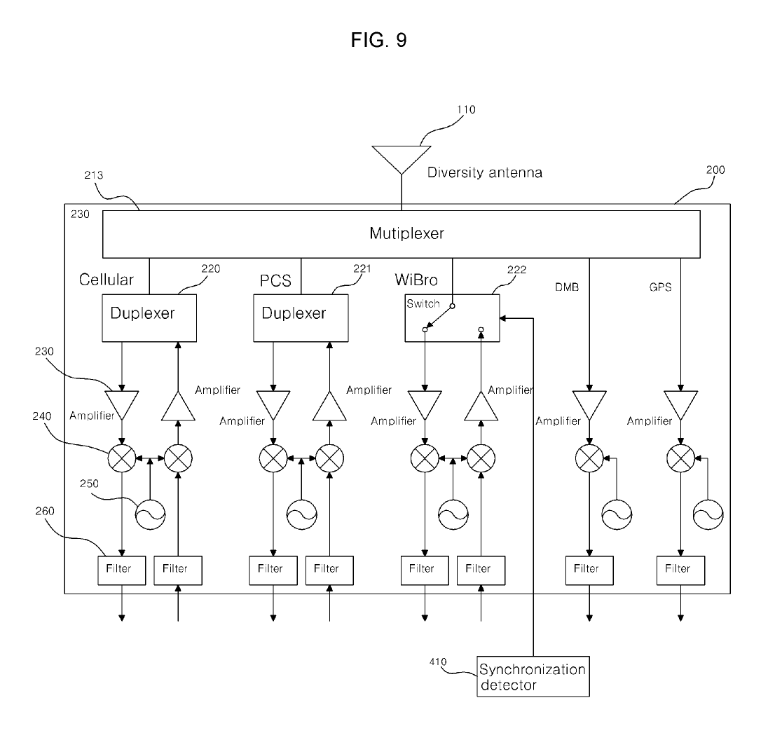

FIG. 9 illustrates a configuration of a RF station 200 at a diversity antenna.

As shown in FIG. 9, a diversity antenna should make an operation in all cellular system, PCS, WiBro, DMB, and GPS system. After being classified from frequencies of each system by a multiplexer 213, an upward signal has to be distinguished from a downward signal because of using FDD communication system in the cellular system and PCS. Then, the downward link signal is distinguished from upward link signal by a duplexer 213. After passing through an amplifier 230, a downward link signal is converted into a base band signal by an oscillator 250. The converted base band signal is distinguished from more precise signal by a filter 260. Because of TDD communication system in a WiBro system, a carrier frequency of an upward link is the same of a downward link, and so it is not herein necessary that a classification about the frequency of upward and downward link signals is made. But, the upward link signal has to be distinguished from the downward link signal in a time area. Then, a synchronization detector 410 at a signal processor 400 is distinguished from upward and downward link signals in WiBro system after receiving a switching signal. After passing through an amplifier 230, a downward link signal is converted into a base band signal by an oscillator 250. The converted base band signal is distinguished from more precise signal by a filter 260. Only downward link signal exists because DMB is a broadcasting system. Therefore, after passing through an amplifier 230 resulting from being distinguished in DMB signal, a downward link signal is converted into a base band signal by an oscillator 250. The converted base band signal is distinguished from more precise signal by a filter 260.

Like DMB, after passing through an amplifier 230 resulting from classifying GPS signal form a multiplexer because only downward link signal exists in case of GPS, a downward link signal is converted into a base band signal by an oscillator 250. The converted base band signal is distinguished from more precise signal by a filter 260.

In case of transmitting from RF stations of FIGS. 5 and 9 to the interior of a vehicle through an inner transmitting antenna 1000, a transmitting signal can act as an interference signal through an outer transmitting antennas 100 and 110. Such situation is a ringing phenomenon, and this phenomenon is generated in case of using the same frequency at inner and outer transmitting antennas 1000, 100 and 110. Such ringing phenomenon can make the isolation reduction of inner and outer transmitting antennas 1000, 100 and 10 by the cover of vehicle and therefore reducing the ringing phenomenon. In addition, being coated on the glass of the vehicle make an electrical wave to be blocked as so to more reduce the ringing phenomenon.

In consideration with another method, there is a method for use Interference Cancellation System as a technology to be used in latest repeater. ICS carries out the tracing phase and magnitude of an output signal and generates a signal of which phase is out of 180 degrees than that of an incidence signal and its magnitude has the same as that of the incidence signal, so offset about a feedback signal may be made. Besides the above described method, there is a method in which a signal passed through an inner antenna 1000 makes to be not received to outer antennas 100 and 110 by making use of the inner antenna 1000 with a diversity antenna.

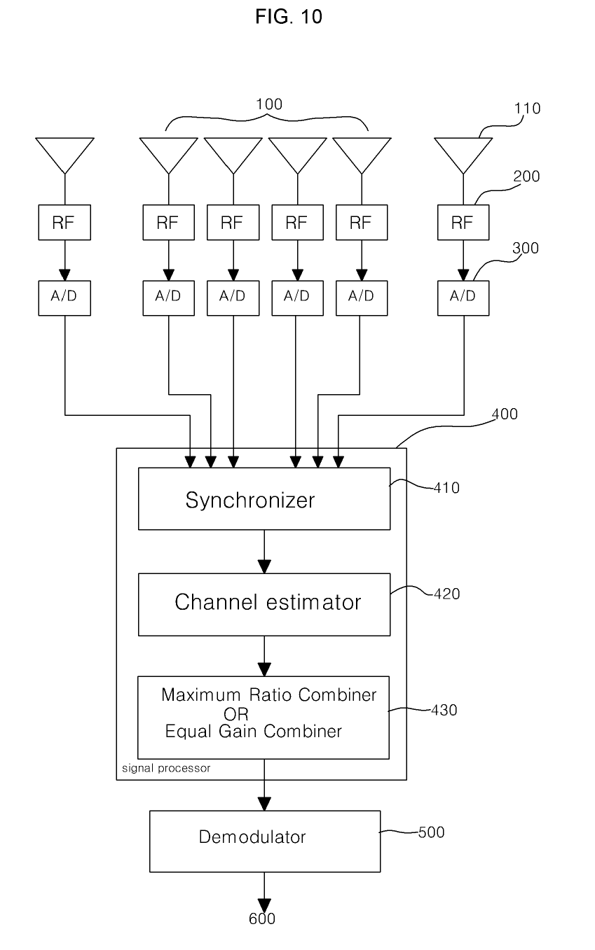

FIG. 10 illustrates a signal processor 400 of DMB and GPS system.

As shown in FIG. 10, a downward link does not exist in DMB system and only an upward link exists therein. Also, DMB system has two methods of which fist method is to re-transmit by demodulation and modulation in a signal processor 400 and second method is to re-transmit by amplifying only a receiving signal.

Considering a signal processor in first method, a signal received through a diversity antenna 110 is converted into a base band signal by a RF station to synchronize with a synchronizer 410 at a signal processor 400 and also a channel of a signal received from a channel estimator 420 is estimated to detect a signal by using MRC method or EGC method which is selected in consideration with a complexity degree of a hardware at a relay system and the performance of the system. To improve the performance of a system, a MRC method of which channel estimation is requested is used and EGC method is used for the purpose of reducing a hardware, the estimated signal is input to RF station 900 through modulator 600 after passing through demodulator 500, and re-transmit to the interior such as vehicle, house, and building through an inner antenna 1000 after being again converted into a base pass signal.

In second method, Intermediate Frequency station makes a signal transformation through RF station like gap filler which utilize at the existing DMB and amplification operation is successively carried out. And, RF signal is sent to the interior of vehicle or building and also demodulated therein. Compared with a method in which modulation is made again after MRC demodulation operation is carried out in a relay by a signal processor, the performance becomes degraded in second method, and it has advantage that it is simple in view of the structure of apparatus.

As described above, there is described for overall receiving and transmitting method and apparatus in consideration with a channel situation, a stationing way, the dual system, the position of a relay, a mobility, and etc for the purpose of improving the performance of a mobile and radio communication system, using a mobile/fixed relay having a multiple antenna. And, a channel correlation measurer, a channel rank measurer, a mobile relay beam-former for a hard handover which is detailed block of the mobile and radio communication system are explained in detail hereinafter.

First, a channel correlation measurer 421 has a way which measures by using a receiving signal and a way which measures by using the value of channel estimation. First mathematical equation following as below represents a way which measures by using a receiving signal.

$$\begin{matrix}ρ = 〈 {y}_{n} , {y}_{m} 〉 \\ = \frac{E [ {y}_{n} {y}_{m} ] - E [ {y}_{n} ] E [ {y}_{m} ]}{\sqrt{( E [ {y}_{n}^{2} ] - {E [ {y}_{n} ]}^{2} ) ( E [ {y}_{m}^{2} ] - {E [ {y}_{m} ]}^{2} )}}\end{matrix} \qquad mathematical equation 1$$

where, yₙ is a signal received to n^{th} antenna, yₘ being a signal received to m^{th} antenna, and E[ ] denotes an average.

Second mathematical equation following as below represents a way which measures by using the value of channel estimation.

$$\begin{matrix}ρ = 〈 {H}_{n} , {H}_{m} 〉 \\ = \frac{E [ {H}_{n} {H}_{m} ] - E [ {H}_{n} ] E [ {H}_{m} ]}{\sqrt{( E [ {H}_{n}^{2} ] - {E [ {H}_{n} ]}^{2} ) ( E [ {H}_{m}^{2} ] - {E [ {H}_{m} ]}^{2} )}}\end{matrix} \qquad mathematical equation 2$$

where, Hₙ is a channel formed to n^{th} antenna, Hₘ being a channel formed to m^{th} antenna, and E[ ] denotes an average.

In measuring a channel correlation the performance of a channel correlation measurement becomes degraded due to the influence of an incidence signal in the way which measures by using a receiving signal. However, a channel correlation measurement is carried out by estimating the channel from each base station to obtain only a correlation value about the channel of a target base station.

A channel rank measurer 425 can calculate an eigen value of a channel matrix and a number of the eigen value other than it is not 0 becomes the rank value. The eigen value can be calculated by mathematical equation 3.

det(Hₘₙ−λIₘₙ)=0 mathematical equation 3

where, Hₙₘ represents a channel formed to an antenna, m represents an antenna, and n denotes a tap of a channel or sub-carrier wave. The eigen value which makes a matrix equation to be 0 can be calculated and when a number of the inherent value other than it is not 0 is checked calculating the rank value is achieved.

A signal to interference ratio measurer 422 can measure a target signal to interference ratio. When a relay existed in a base station near, the value of the measured signal to interference ratio is larger than a standard value. At this time, the influence of an interference signal about a target signal becomes low to apply MRC method which illustrates the best performance in case of having no interference.

When a relay existed in a base station so far where a cell boundary area is expressed, however, the value of the measured signal to interference ratio is smaller than a standard value. This situation is given from a big influence of the interference signal at the next cell to apply a beam forming method which use a beam-forming antenna and an interference cancellation method which use a diversity antenna for the purpose of eliminating interference. Mathematical equation 4 represents a signal-to-interference equation.

$$• SIR = 10 {log}_{10} \{ \frac{{\sum }_{i = 0}^{N} y ( \begin{matrix}{N}_{Spacing} \times i + \\ {N}_{offset} + {S}_{T}\end{matrix} ) \times {P}_{T} ( i )}{{\sum }_{k = 0}^{N} \{ {\sum }_{i = 0}^{N} y ( \begin{matrix}{N}_{Spacing} \times i + \\ {N}_{offset} + {S}_{k}\end{matrix} ) \times {P}_{k} ( i ) \}} \} \qquad mathematical equation 4$$

where, y represents a received signal, P_{T} the preamble of a target signal, Pₖ the preamble of k^{th} interference signal, N_{spacing} the spacing of frequencies in a preamble signal, N_{Int1} the number of interference signals, Nₚ the number of preamble sub-carrier wave, N_{offset} the offset of preamble sub-carrier wave, S_{T} the segment of a target signal, and Sₖ represents the segment of k^{th} interference signal.

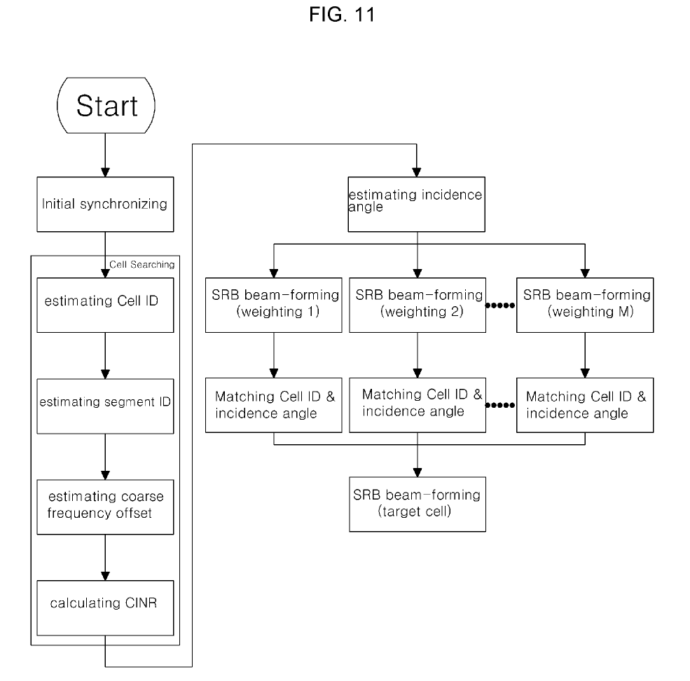

FIG. 11 illustrates first method capable of employing in a mobile relay beam-former for hard handover. First method is to carry out a cell searching in a mobile/fixed relay having multiple antenna and to estimate an incidence angle and also the estimation of the incidence in the mobile/fixed relay is made after the synchronization process and cell searching have been finished. An initial synchronizing is made in the relay and a cell ID can be estimated by cell searching about a target base station. After both the synchronization process and the cell searching have been finished, the incidence angle is estimated and SRB beam-forming is made about the corresponding incidence angle to be parallel with a cell ID. However, there is a weakness for which it takes much time by such method to do.

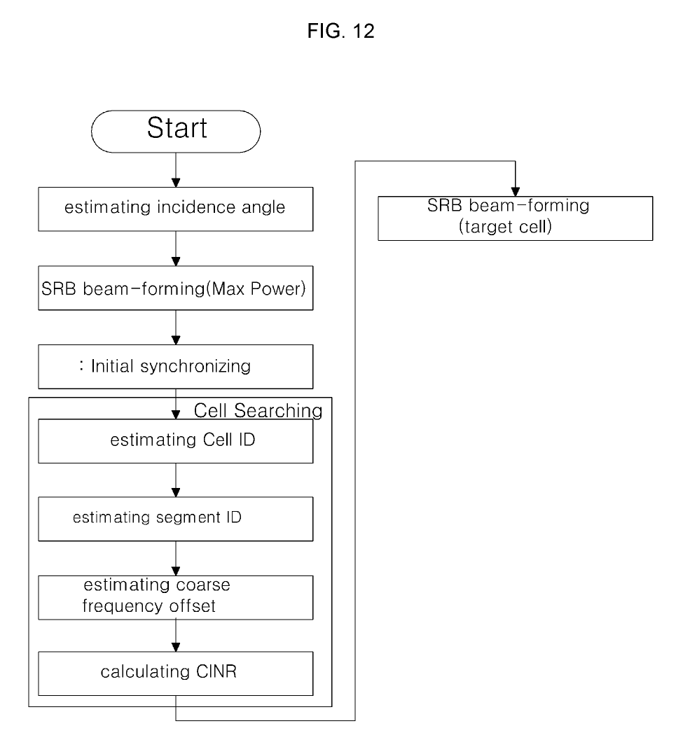

FIG. 12 illustrates second method capable of employing in a mobile relay beam-former for hard handover. Second method is the estimation of the incidence in the mobile/fixed relay is made before the synchronization process and to form a beam in a direction of having a biggest electrical power to an incidence to be estimated. The method is to carry out the initial synchronizing and the cell tracing to beam formed signal and also there is a weakness for which it takes much time by such method to do.

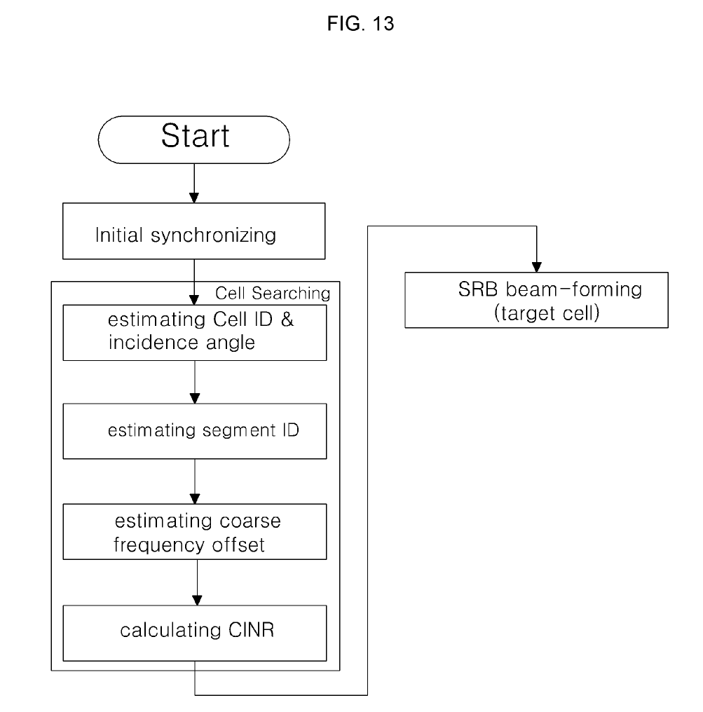

FIG. 13 illustrates third method capable of employing in a mobile relay beam-former for hard handover, in which an initial synchronization is made in the relay and a cell ID & incidence angle of a target base station can be estimated simultaneously. After a simultaneous estimation about a cell ID & incidence angle of a target base station is carried out, the third method is to at the same time estimate the incidence angle by using a receiving signal and the correlation value of a preamble signal and therefore it is takes little time, compared with first and second method.

As one embodiment, a cell searching process in OFDMA cellular system like WiBro calculates a inter-correlation by using a receiving signal to be received through an antenna and a plurality of a base signal which was already known in terminal to estimate a cell ID of a base signal having a maximum value as a cell ID of a target base station

Mathematical equation 5 represents a correlation equation which use in a cell searching.

$$C = max \vert {\sum }_{n = 0}^{N - 1} {{y}_{n}^{I} ( {x}_{n}^{c} )}^{*} \vert \qquad mathematical equation 5$$

where, C represents a cell ID, and y^{I}ₙ represents n^{th} sub-carrier wave received to I^{th} antenna. Further, X^{c}ₙ represents n^{th} preamble signal of a cell ID.

In embodiments according to the present invention, there are three methods to simultaneously carry out the cell searching and the estimation of an incidence angle.

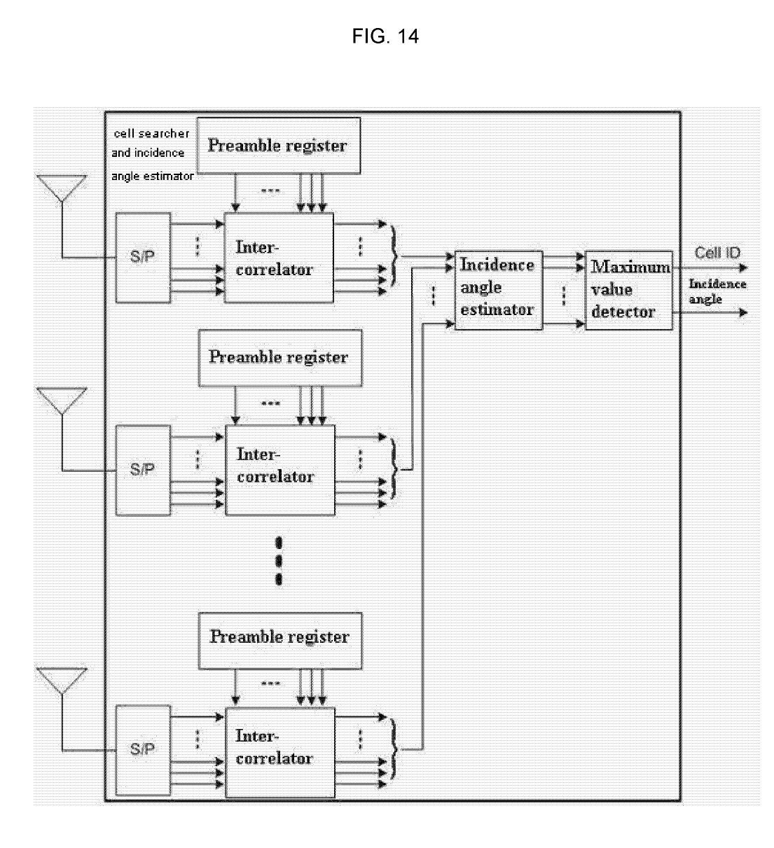

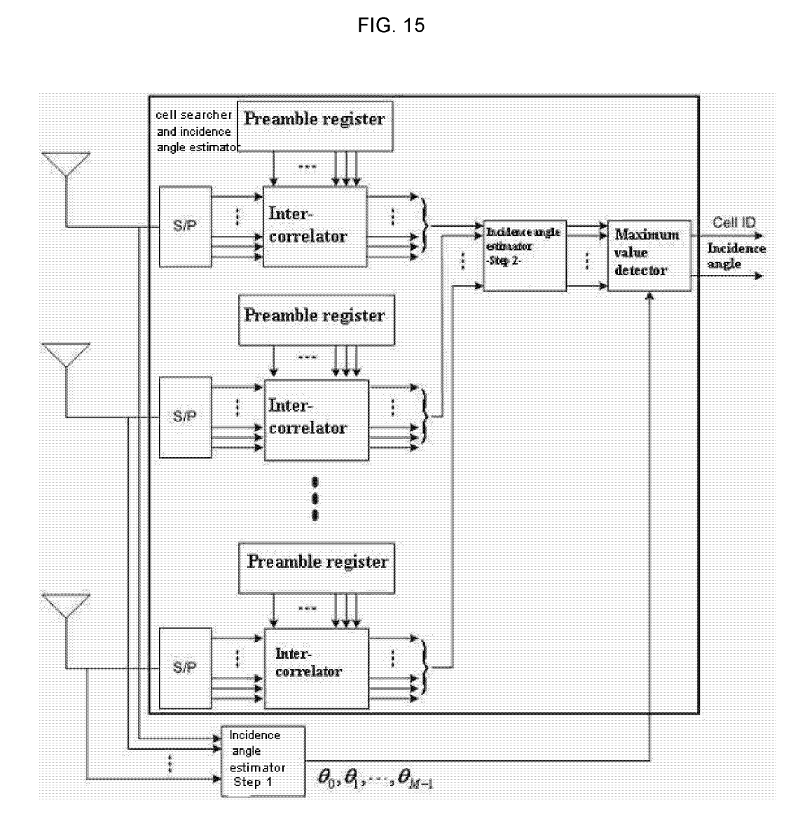

FIG. 14 illustrates first method in which a simultaneous estimation about a cell ID & incidence angle of a target base station is carried out. First simultaneous estimation method is to estimate a cell ID & incidence angle by using a mutual correlation matrix to a received signal and every preamble signal, in which a cell ID & incidence angle can be estimated by calculating a self-correlation matrix of the mutual correlation matrix after the mutual correlation matrix to the preamble and the received signal is calculated in advance.

In order to be simultaneously estimated by each cell searching, mathematical equation 6 represents the incidence angle estimation method to the delayed sum, mathematical equation 7 the incidence angle estimation method to Minimum Variance Distortionless Response, and mathematical equation 8 represents the incidence angle estimation method to Multiple Signal Classification.

$$\begin{matrix}( C , θ ) = {max}_{c , θ} ( {a ( θ )}^{H} {R}_{c} a ( θ ) ) & mathematical equation 6 \\ ( C , θ ) = {max}_{c , θ} ( \frac{1}{{a ( θ )}^{H} {R}_{c}^{- 1} a ( θ )} ) & mathematical equation 7 \\ ( C , θ ) = {max}_{c , θ} ( \frac{1}{{a ( θ )}^{H} {( {V}_{c} )}_{n} {( {V}_{c} )}_{n}^{H} a ( θ )} ) & mathematical equation 8\end{matrix}$$

where, R_{c} represents a self-correlation vector in a mutual correlation matrix to a preamble and a received signal, a(θ) an adjusting vector to an incidence angle, and (V_{c})ₙ represents a sub-space vector on a distortion, in which when a value at the mathematical equation is most higher, a C value becomes a cell ID(C) and a θ value becomes the incidence angle. Out of three methods, there is a highest complexity degree in the methods which use mathematical equation 8, but there is a trade-off between the complexity degree and the performance because of having a higher resolution, compared to other methods.

FIG. 15 illustrates second method in which a simultaneous estimation about a cell ID & the incidence angle of a target base station is carried out. Second simultaneous estimation method is to assume a cell ID & an incidence angle only to the further incidence angle after some of further incidence angles are estimated from a received signal. Second simultaneous estimation method consists of two steps, first step being to assume some of further incidence angles using an incidence angle estimation method to the received signal and second step being to assume a cell ID & an incidence angle using a self-correlation matrix of the mutual correlation matrix after calculating the mutual correlation matrix of the preamble and a received signal.

The incidence angle estimation carries out a search only to further incidence angle calculated in first step. A mathematical equation at first step follows as below.

$$\begin{matrix}P ( θ ) = {max}_{θ} ( {a ( θ )}^{H} Ra ( θ ) ) & mathematical equation 9 \\ P ( θ ) = {max}_{θ} ( \frac{1}{{a ( θ )}^{H} {R}^{- 1} a ( θ )} ) & mathematical equation 10 \\ P ( θ ) = {max}_{θ} ( \frac{1}{{a ( θ )}^{H} {V}_{n} {V}_{n}^{H} a ( θ )} ) & mathematical equation 11\end{matrix}$$

Mathematical equations 9, 10, and 11 represent delayed sum incidence angle estimation method, a MVDR incidence angle estimation method, and a MUSIC incidence angle estimation method. At this time, R represent a self-correlation matrix to a received signal. Cell ID & incidence angle may be estimated using the mutual correlation function to a received and a preamble signal in second step and further incidence angle in first step.

$$( C , θ ) = {max}_{θ} ( {a ( {θ}_{m} )}^{H} {P}_{c} ) , \\ m = 0 , 1 , ⋯ , M - 1 \qquad mathematical equation 12$$

where, uₘ represents estimated further incidence angle in first step, and M represents a number of further incidence angle.

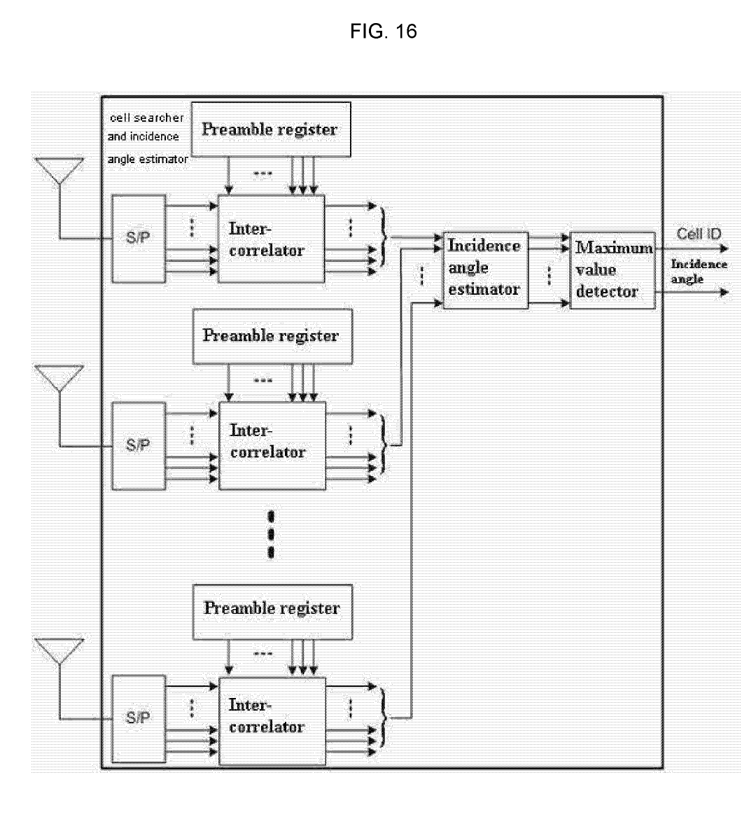

FIG. 16 third simultaneous estimation method is to assume an incidence angle of a received signal from a base station to a mobile/fixed relay by using the mutual correlation function of a preamble and a received signal. At this time, an incidence angle estimation method is Direct Searching, Peak Searching, and Joint Peak Searching method.

Mathematical Equation 13 Represents Direct Searching method.

$$θ = asin \{ E [ \frac{ln ( {P}_{C}^{I} / {P}_{C}^{I - 1} )}{- j2π d / λ} ] \} \qquad mathematical equation 13$$

where, P^{I}_{c} represents a mutual correlation value to a received signal from an I^{th} antenna and a preamble signal of the cell ID, d a distance on the antenna, and λ represents a wavelength. The direct searching method can search out a θ value at which a product of the adjusting vector become the maximum in a state of searching out the cell ID.

Mathematical equation 14 represents Peak Searching method.

$$θ = {max}_{θ} ( {a ( θ )}^{H} {P}_{C} ) \qquad mathematical equation 14$$

where, P_{c} represents a mutual correlation value to a received signal from an I^{th} antenna and a preamble signal of the cell ID, a distance on the antenna, and λ represents a wave length.

Mathematical equation 15 represents Joint Peak Searching method.

$$( C , θ ) = {max}_{c , θ} ( {a ( θ )}^{H} {P}_{c} ) \qquad mathematical equation 15$$

Joint Peak Searching method does not rather search an incidence u after searching a cell ID c than search a cell ID & an incidence angle at which a product of the adjusting vector become the maximum after calculating a received signal and a mutual correlation to a possible cell ID. In the above simultaneous estimation methods about a cell ID & the incidence angle, it takes little time to assume it in first method and a complication degree is very low, compared to other two methods.

Hereinafter, the existing SRB beam-forming method and TRB beam-forming method is briefly described as a beam-forming method to be used in FIGS. 6, 7, and 8.

SRB beam-forming method is a beam-forming method on the basis of incidence information which contains in a signal, and herein belongs to a delayed sum beam-forming, null adjusting beam-forming, and MVDR beam-forming methods. The delayed sum beam-forming method has the weighting value of the same magnitude every each antenna and a phase is selected as so to synchronize with a desired direction. Such delayed sum beam-forming method can carries out a good operation if only one signal exist. However, when one or more of interference signal is additionally incidented, the performance becomes degraded highly.

The null adjusting beam-forming method is able to use when both the incidence angle of a desired direction and the incidence angle of an interference signal is known.

Because the interference signal is effectively eliminated when the direction of the interference signal is known in the null adjusting beam-forming method, the null adjusting beam-forming method is adaptable to eliminate jamming signal. To maintain a gain in a desired direction and minimize an out power of the undesired interference signal acts as a weak influence on interference.

SRB beam-forming method has to know an incidence angle of a target signal to form a beam, and so an incidence angle of an interference signal has to be additionally known. The incidence angle estimation method includes delayed sum, MVDR, MUSIC, and Estimation of Signal Parameters via Rotational Invariance methods. The delayed sum method is one of a simplest incidence angle estimation method and assume an angle by measuring an output power to a discontinuous area differently form each other in an angle region.

The estimation of an incidence angle by MVDR method illustrates the best performance than that in the delayed sum method. Because it is not to spatially minimize an interference signal in environment at which is in a correlation characteristics, however, the estimation of an incidence angle becomes failed. MUSIC method is even the method which illustrates the very high performance is very precise using an inherent structure of the self-correlation matrix of the input signal, and correct arrangement proofreading is needed.

ESPRIT method uses rotation displacement invariance of the signal subspace caused by linear displacement invariance of the antenna array under the assumption that the array exists with groups in the same distance while having displacement invariance, such that direct identification of the incidence angle from eigen value causes no requiring of the cell searching process for the whole angle, and no requiring of relatively precise array calibration.

TRB beam-forming method is a method forming a beam based on training signals, which includes beam-forming algorithms of LMS (Least Mean Square), RLS (Recursive Least Square) and SMI (Sample Matrix Inversion). Where SMI beam-forming method finds an inverse matrix of self-correlation matrix with ease to obtain an optimal coefficient, such that the self-correlation matrix and the inter-correlation matrix can be directly calculated based on the samples of signals incidented into antennas. In this case, the length of the samples should be two times or more of the number of minimum antenna. The convergence rate of SMI beam-forming method is faster than that of LMS, and is regardless of eigen value diffusion, receiving power and other parameters. However, disadvantage exists in that there are lots of amount of calculation.

Interference cancellation method will be described hereinbelow.

Interference cancellation method detects particular signals from receiving signals and removes other signals to be considered as interference signals, such that it can minimize the effects of other signals. Interference cancellation method includes ZF Nulling, MMSE Nulling, ML and the like. ZF Nulling considers an inverse matrix of a channel vector as a weight vector to remove the interference signals. ZF Nulling has a disadvantage in that noises are amplified to degrade the performance due to no consideration about the noises. MMSE Nulling is similar to ZF Nulling, but since it minimizes MSE to amplify the noises without degrading the performance, it has an improved performance compared to ZF Nulling. ML searches all the transmittable symbols to select a minimum squared Euclidean distance, thereby serving a most excellent performance, but the amount of calculation increases exponentially with the number of transceiving antenna and the order of modulation.

Hereinbelow, several primary situations are shown as an example of the present embodiment.

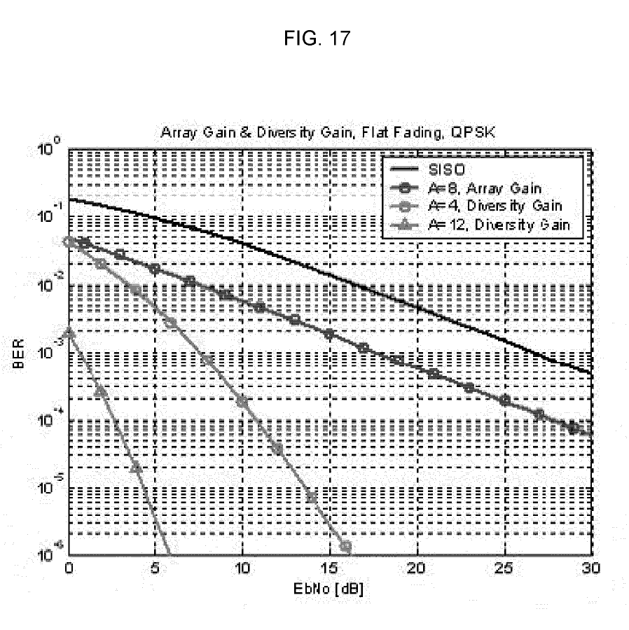

FIG. 17 illustrates the beam-forming gain in the specular channel and the diversity gain in the scattering channel as an ideal situation. As noted in the figure, the beam-forming gain indicates that when using eight beam-forming antennas is supposed, the performance was improved by about 9 dB compared to using a single antenna. In addition, the diversity gain in using only four diversity antennas and using both the diversity antenna and the beam-forming antenna indicates that the performance was improved by about 19 dB and 26 Db, respectively, compared to using a single antenna in BER (Bit Error Rate).

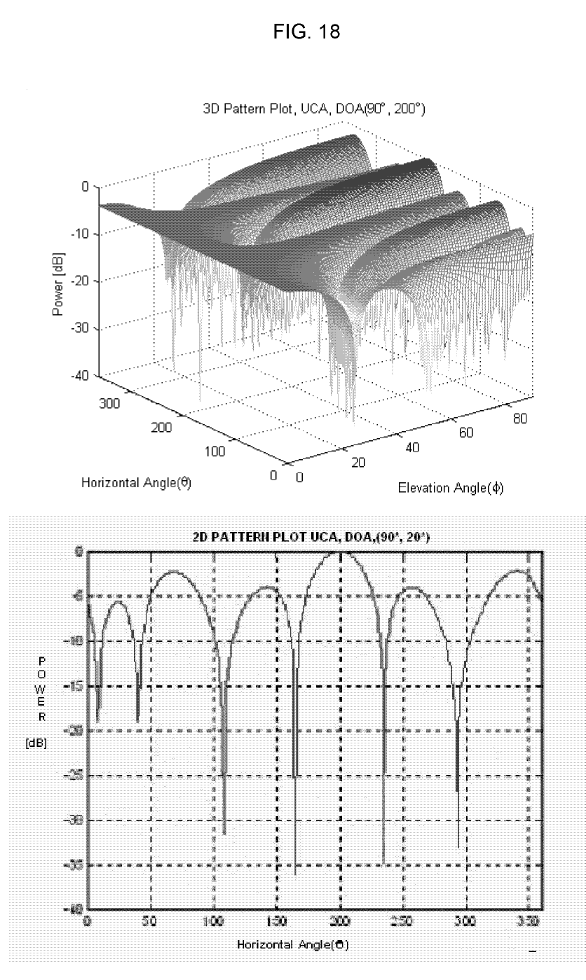

FIG. 18 illustrates a beam-forming pattern, when the beam was formed in a manner of Null-Steering based on SRB using the circular array antennas, wherein the interval of antennas is a half wavelength, the vertical incidence angle of the target signal (A) is 90 degrees and the horizontal incidence angle is 200 degrees. This figure indicates that the beam was precisely formed for the vertical and horizontal incidence angle of the target signals.

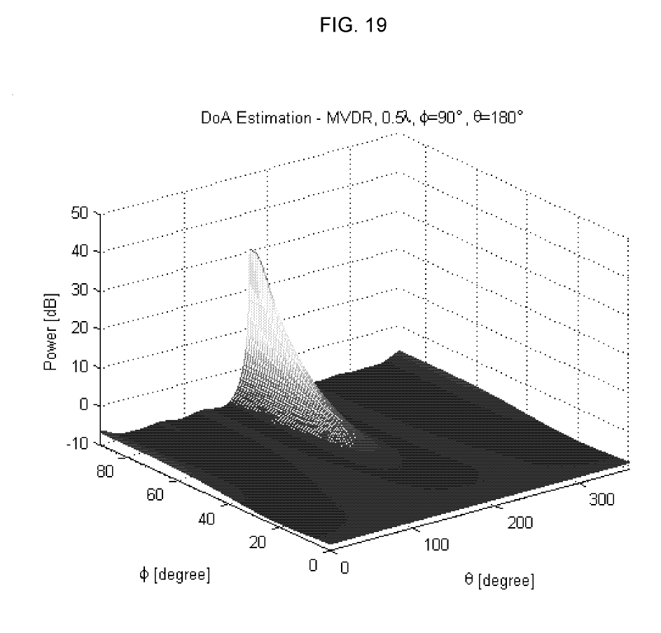

FIG. 19 illustrates the estimated results of the incidence angle in the target signals using MVDR type. This figure illustrates the results received in the circular array antenna at which the interval of antennas is a half wavelength, the vertical incidence angle of the target signal (A) is 90 degrees and the horizontal incidence angle (u) is 180 degrees. As noted in this figure, the incidence angle was precisely estimated for the vertical and horizontal incidence angle of the target signals.

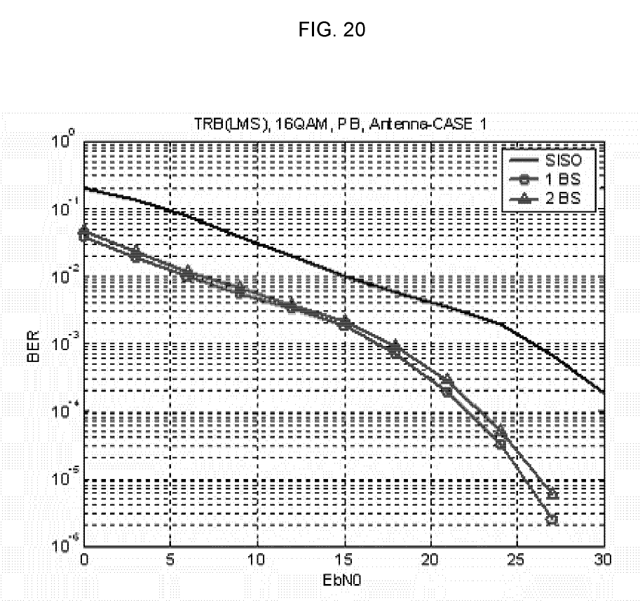

FIG. 20 illustrates BER capability in forming a TRB beam employing LMS algorithm using a beam-forming antenna in the specular channel of Pedestrian B model.

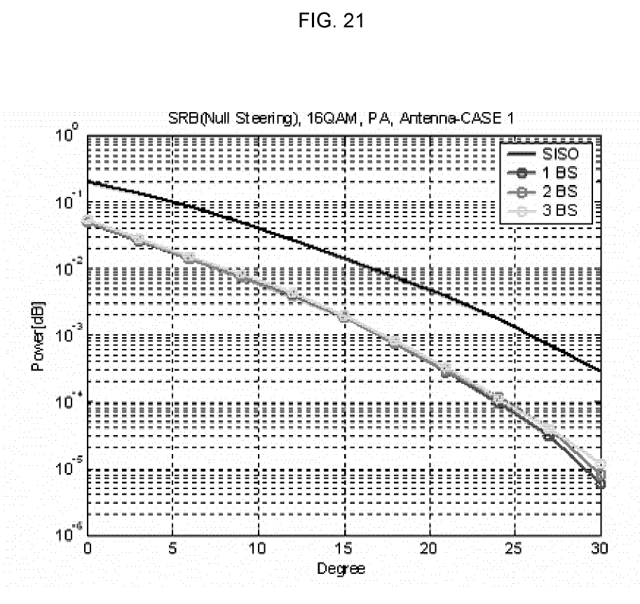

FIG. 21 illustrates BER capability in forming a Null-Steering beam based on SRB using a beam-forming antenna in the specular channel of Pedestrian B model. It indicates that the beam-forming gain of about 9 dB was obtained.

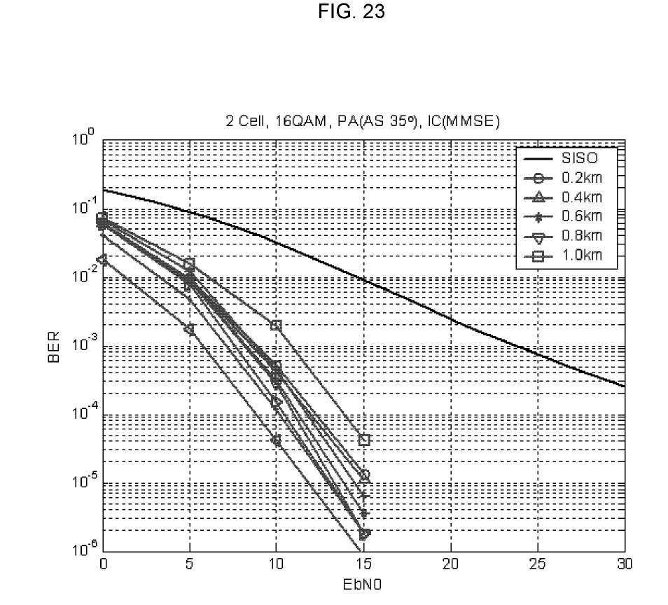

FIG. 23 illustrates BER capability in applying a MRC method using a diversity antenna in the scattering channel of Pedestrian A model. In this figure, the cell radius was supposed by 1 Km, and the capability was illustrated in which the relay was present spaced apart 0.2 Km to 1.0 Km from the cell center. Since, when the relay is inside the cell (0.2 Km), the effects of the interference signals are small, it is noted that sufficient diversity gain can be obtained. Since, however, as the relay moves toward the cell boundary (1.0 Km), the effects of the interference signals increase, it is noted that the performance degrades greatly.

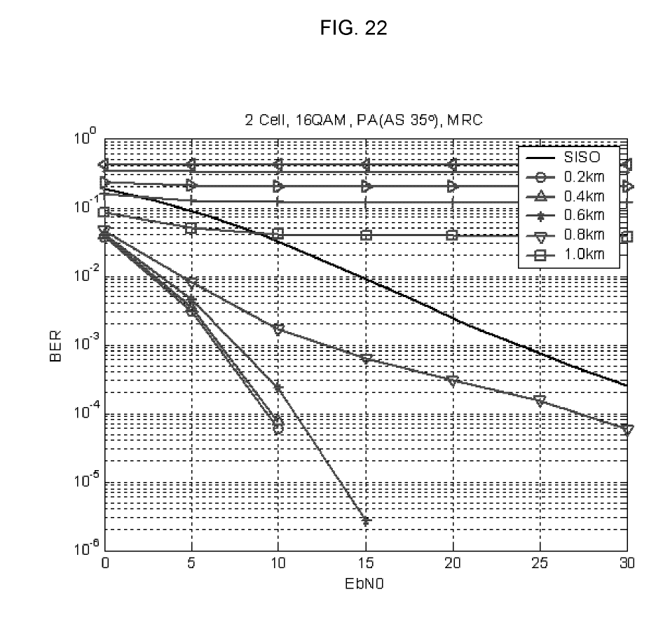

FIG. 24 illustrates BER capability in applying an interference cancellation method using the diversity antenna in the same environment with FIG. 22. The comparison with FIG. 22 indicates that when the relay exists in the cell boundary, there was no large degradation of the performance in the interference cancellation method. This is because the interference cancellation method efficiently removes the interference between the cells.

It should be understood that this invention is not limited to the particular embodiments disclosed herein, but it is intended to cover modifications or changes within the spirit and scope of the present invention as defined by the appended claims.

### INDUSTRIAL APPLICABILITY

As described in detail hereinabove, the present invention is expected to obtain greatly improved performances in the beam-forming gain and the diversity gain when using the method and apparatus for a transceiver of the mobile/fixed relay with multiple antennas suggested herein, compared to the conventional wireless communication terminal using a single antenna.

In addition, although the conventional wireless communication terminal using a single antenna or minimal multiple antennas has limited performance by the interferences between the cells, fading and the like due to the spatial constraint, the present invention can greatly improve the performance in obtaining the cancellation of the interference between the cells, the beam-forming gain or the diversity gain when using the method and apparatus for a transceiver of the mobile/fixed relay with multiple antennas suggested herein.

Further, the present invention can greatly improve the reliability and the product quality (e.g., sound quality, image quality, etc.) of signals by using a method for transceiving of the mobile/fixed relay and an antenna configuration optimized in the situation, in view of carrier frequency, dual type, handover type, position of the mobile/fixed relay, channel environment, mobility, etc. in the wireless communication system, such as cellular system, PCS, WiBro, DMB, GPS, etc.

1. A transceiver for a mobile/fixed relay with multiple antennas, comprises the mobile/fixed relay in which a beam-forming antenna and a diversity antenna are coupled to improve a performance of a mobile communication system or a wireless broadcasting system, such as a cellular system, a PCS, a WiBro, a DMB and a GPS.

2. A transceiver for a mobile/fixed relay with multiple antennas of claim 1, wherein the beam-forming antenna employs an array antenna of a multiple circular configuration for multiple band, and the diversity antenna employs a dual polarized antenna for multiple band.

3. A transceiver for a mobile/fixed relay with multiple antennas of claim 2, wherein each interval of the antenna of the circular array antenna is a half wavelength.

4. A transceiver for a mobile/fixed relay having with multiple antennas of claim 2, wherein the circular array antenna is disposed in a half wavelength on the basis of a highest carrier frequency, or in a half wavelength on the basis of a lowest carrier frequency, or in a half wavelength of an average frequency in the multiple band.

5. A transceiver for a mobile/fixed relay with multiple antennas of claim 2, wherein an antenna element of the array antenna is embodied by an omni-directional antenna with a planar vertical polarized wave property.

6. A transceiver for a mobile/fixed relay with multiple antennas of claim 2, wherein the circular array antenna is united with a multiplexer.

7. A transceiver for a mobile/fixed relay with multiple antennas of claim 1, wherein the beam-forming antenna is at least one of a single circular antenna, a dual circular antenna and a triple circular antenna.

8. A transceiver for a mobile/fixed relay with multiple antennas able to improve a performance of mobile communication system in TDD communication system, which comprises:
an outer receiving antenna, comprising a beam-forming antenna and a diversity antenna, for receiving signals of each mobile communication system for a downward link signal;
a RF station for separating the signals received from the outer receiving antenna into signals of each mobile communication system and converting then into base-band signals;
an A/D converter for converting the signals converted into the base-band signals from analog signals into digital signals;
a synchronizer part for estimating and compensating synchronization from the signals converted into the digital signals;
a cell searcher for searching a target base station from the signals undergoing the synchronization process;
a channel estimator for estimating a channel from the signal undergoing the cell searching process;
a channel correlation measurer for measuring a correlation between the beam-forming antenna from the signals undergoing the channel estimator;
a channel rank measurer for measuring a channel rank between the beam-forming antennas from the signals undergoing the channel estimator;
a signal to interference ratio measurer for measuring a signal ratio of a target base station to an interference base station from the signals undergoing the channel estimator;
a channel correlation selector for selecting whether or not using a mobile/fixed relay beam-former for hard handover from the channel correlation value and the channel rank value;
a signal to interference ratio selector for selecting whether using a MRC or using an interference canceller from an estimated value of the signal to interference ratio, the channel correlation value and the channel rank value;
a mobile/fixed relay beam-former for hard handover used when the channel correlation value is larger than a reference channel correlation value, or the channel rank value is smaller than a reference channel rank value;
the MRC used when the channel correlation value is smaller than the reference channel correlation value, or the channel rank value is larger than the reference channel rank value, and the estimated value of the signal to interference ratio is larger than the value of the signal to interference ratio;
the interference canceller used when the channel correlation value is smaller than the reference channel correlation value, or the channel rank value is larger than the reference channel rank value, and the estimated value of the signal to interference ratio is smaller than the value of the signal to interference ratio;
a demodulator for demodulating from detected signals;
a modulator for modulating the demodulated signals;
a D/A converter for converting the modulated signals into the analog signals; and
an inner antenna for transmitting the converted signals to an inner terminal.

9. A transceiver for a mobile/fixed relay with multiple antennas able to improve a performance of wireless communication system in TDD communication system, which comprises:
an inner receiving antenna, comprising a beam-forming antenna and a diversity antenna, for receiving signals of each wireless communication systems for downward link signal;
a RF station for separating the signals received from the inner receiving antenna into each communication system signals and converting them into base-band signals;
an A/D converter for converting the signals converted into the base-band signals from analog signals into digital signals;
an equalizer for equalizing a channel from the signals converted into the digital signals;
a demodulator for demodulating from the signals undergoing the equalization process;
a modulator for modulating from the demodulated signals;
a selector for selecting whether using a mobile relay beam-former for hard handover and a MRT, or an interference canceller;
a mobile/fixed relay beam-former for hard handover used in upward link when selecting the mobile/fixed relay beam-former for hard handover in downward link by the selector;
a MRT used in the upward link when selecting the MRT in the downward link by the selector;
an interference canceller used in the upward link when selecting the interference canceller in the downward link by the selector;
a D/A converter for converting pre-coded signals into analogue signals through the mobile/fixed relay beam-former for hard handover, the MRT and the interference canceller;
a RF station for converting into pass-band signals for the signals converted into the analogue signals; and
an outer antenna for transmitting the signals converted into the pass-band signals to a base station.

10. A transceiver for a mobile/fixed relay with multiple antennas able to improve a performance of mobile communication system in FDD communication system, which comprises:
an outer receiving antenna, comprising a beam-forming antenna and a diversity antenna, for receiving signals of each mobile communication systems for downward link signal;
a RF station for separating the signals received from the outer receiving antenna into each mobile communication system signals and converting them into base-band signals;
an A/D converter for converting the signals converted into the base-band signals from analog signals into digital signals;
a synchronizer part for estimating and compensating a synchronization from the signals converted into the digital signals;
a cell searcher for searching a target base station from the signals undergoing the synchronization process;
a mobile/fixed relay beam-former for soft handover for forming a beam for soft handover from the signals undergoing the cell searching process;
a channel estimating part for estimating a channel from the beam-formed signals.
an equalizer for equalizing the beam-formed signals into estimated signals;
a demodulator for demodulating from the signals detected through the equalizer;
a modulator for modulating the demodulated signals;
a D/A converter for converting the modulated signals into analog signals; and
an inner antenna for transmitting the converted signals to an inner terminal.

11. A transceiver for a mobile/fixed relay with multiple antennas able to improve a performance of a mobile communication system in FDD communication system, which comprises:
an inner receiving antenna, comprising a beam-forming antenna and a diversity antenna, for receiving signals of each mobile communication systems for upward link signal;
a RF station for separating the signals received from the inner receiving antenna into each communication system signals and converting them into base-band signals;
an A/D converter for converting the signals converted into the base-band signals from analog signals into digital signals;
an equalizer for equalizing the channel from the signals converted into the digital signals;
a demodulator for demodulating from the signals undergoing the equalization process;
a modulator for modulating from the demodulated signals;
a mobile/fixed relay beam-former for soft handover for pre-coding from the modulated signals;
a D/A converter for converting the pre-coded signals into the analogue signals through the mobile/fixed relay beam-former for soft handover;
a RF station for converting into pass-band signals for the signals converted into the analogue signals; and
an outer antenna for transmitting the signals converted into the pass-band signals to a base station.

12. A transceiver for a mobile/fixed relay with multiple antennas able to improve a performance of a wireless communication system in broadcasting communication system, which comprises:
an outer receiving antenna, comprising a beam-forming antenna and a diversity antenna, for receiving signals of each wireless communication systems;
a RF station for separating the signals received from the outer receiving antenna into each wireless communication system signals and converting them into base-band signals;
an A/D converter for converting the signals converted into the base-band signals from analog signals into digital signals;
a synchronizer part for estimating and compensating a synchronization from the signals converted into the digital signals;
a channel estimator for estimating a channel from the signals undergoing the synchronizer part;
a MRC or EGC for detecting the signals after the channel estimating process;
a demodulator for demodulating from the detected signals;
a modulator for modulating the demodulated signals;
a D/A converter for converting the modulated signals into analog signals; and
an inner antenna for transmitting the converted signals to an inner terminal.

13. A transceiver for a mobile/fixed relay with multiple antennas of claim 8, wherein when a beam-former is selected, a circular array antenna which is the beam-former is used.

14. A transceiver for a mobile/fixed relay with multiple antennas of claim 8, wherein the MRC employs a signal of the diversity antenna.

15. A transceiver for a mobile/fixed relay with multiple antennas of claim 9, wherein a MTC employs a signal of the diversity antenna.

16. A transceiver for a mobile/fixed relay with multiple antennas of claim 8, wherein the interference canceller employs a signal of the diversity antenna.

17. A transceiver for a mobile/fixed relay with multiple antennas of claim 8, wherein the channel correlation measurer estimates a signal received from the circular array antenna using a math equation as bellow,
$$\begin{matrix}ρ = 〈 {y}_{n} , {y}_{m} 〉 \\ = \frac{E [ {y}_{n} {y}_{m} ] - E [ {y}_{n} ] E [ {y}_{m} ]}{\sqrt{( E [ {y}_{n}^{2} ] - {E [ {y}_{n} ]}^{2} ) ( E [ {y}_{m}^{2} ] - {E [ {y}_{m} ]}^{2} )}}\end{matrix}$$
where yn is a signal received in nth antenna, ym is a signal received in m^{th} antenna, and E[ ] denotes an average.

18. A transceiver for a mobile/fixed relay with multiple antennas of claim 8, wherein the channel correlation measurer employs a circular array antenna and estimates a channel correlation between the antennas using a math equation as bellow,
$$\begin{matrix}ρ = 〈 {H}_{n} , {H}_{m} 〉 \\ = \frac{E [ {H}_{n} {H}_{m} ] - E [ {H}_{n} ] E [ {H}_{m} ]}{\sqrt{( E [ {H}_{n}^{2} ] - {E [ {H}_{n} ]}^{2} ) ( E [ {H}_{m}^{2} ] - {E [ {H}_{m} ]}^{2} )}}\end{matrix}$$
where Hn is a channel input through nth antenna, Hm is a channel input through mth antenna, and E[ ] denotes an average.

19. A transceiver for a mobile/fixed relay with multiple antennas of claim 8, wherein the channel rank measurer using a channel value employs a circular array antenna and measures a channel rank between the antennas using a math equation as bellow,
det(Hₘₙ−λIₘₙ)=0
where Hnm denotes a channel input through an antenna, m denotes an antenna and n denotes a tap or a sub-carrier of a channel.

20. A transceiver for a mobile/fixed relay with multiple antennas of claim 8, wherein the signal to interference ratio measurer estimates the ratio of a signal of a target base station to a signal of a adjacent base station acting as an interference, using a math equation as bellow,
$$• SIR = 10 {log}_{10} \{ \frac{{\sum }_{i = 0}^{N} y ( \begin{matrix}{N}_{Spacing} \times i + \\ {N}_{offset} + {S}_{T}\end{matrix} ) \times {P}_{T} ( i )}{{\sum }_{k = 0}^{N} \{ {\sum }_{i = 0}^{N} y ( \begin{matrix}{N}_{Spacing} \times i + \\ {N}_{offset} + {S}_{k}\end{matrix} ) \times {P}_{k} ( i ) \}} \}$$
where y denotes a received signal, PT denotes a preamble of a target signal, Pk denotes a preamble of kth interference signal, NSpacing denotes an interval between the frequencies of a preamble signal, NInt1 denotes the number of an interference signal, Np denotes the number of preamble sub-carrier wave, Noffset denotes an sub-carrier offset of preamble, ST denotes a segment of a target signal, and Sk denotes a segment of kth interference signal.

21. A transceiver for a mobile/fixed relay with multiple antennas of claim 8, wherein the cell searcher performs a searching an incidence angle and a cell, using a math equation as bellow,
$$( C , θ ) = {max}_{c , θ} ( {a ( θ )}^{H} {R}_{c} a ( θ ) )$$
$$( C , θ ) = {max}_{c , θ} ( \frac{1}{{a ( θ )}^{H} {R}_{c}^{- 1} a ( θ )} )$$
$$( C , θ ) = {max}_{c , θ} ( \frac{1}{{a ( θ )}^{H} {( {V}_{c} )}_{n} {( {V}_{c} )}_{n}^{H} a ( θ )} )$$
where Rc denotes a self-correlation vector in an inter-correlation matrix of a preamble and a received signal, a(θ) denotes a adjusting vector for an incidence angle θ, (Vc)n denotes a noise sub-space vector, and C becomes Cell ID(C) and θ becomes an incidence angle when each of the above equations becomes maximum.

22. A transceiver for a mobile/fixed relay with multiple antennas of claim 21, wherein some candidate of incidence angles is estimated from the received signals prior to estimation of Cell ID and incidence angle only for the candidate of the incidence angle, and wherein the candidate of the incidence angle is estimated in a first step,
$$P ( θ ) = {max}_{θ} ( {a ( θ )}^{H} Ra ( θ ) )$$
$$P ( θ ) = {max}_{θ} ( \frac{1}{{a ( θ )}^{H} {R}^{- 1} a ( θ )} )$$
$$P ( θ ) = {max}_{θ} ( \frac{1}{{a ( θ )}^{H} {V}_{n} {V}_{n}^{H} a ( θ )} )$$
where R denotes a self-correlation matrix for a received signal, a(θ) denotes a adjusting vector for an incidence angle θ, M (M is a natural number) of θ value becomes the candidate of the incidence angle in each equations, and the cell ID & incidence angle are estimated in a second step using the candidate of the incidence angle,
$$( C , θ ) = {max}_{c , θ} ( {a ( {θ}_{m} )}^{H} {P}_{c} ) , m = 0 , 1 , ⋯ , M - 1$$
where, θm means the candidate of the incidence angle estimated from the first step, M denotes the number of the candidate of the incidence angle, and the cell searching and the incidence angle is simultaneously estimated using the above equation.

23. A transceiver for a mobile/fixed relay with multiple antennas of claim 21, wherein direct searching, peak searching and joint peak searching method are used in simultaneously estimating the cell searching and the incidence angle which can estimate the cell ID & the incidence angle, using the inter-correlation matrix of the preamble and the received signals.

24. A transceiver for a mobile/fixed relay with multiple antennas of claim 23, wherein the estimator of the direct searching method is to search a 0 value at which the product of the adjusting vectors becomes a maximum, while completing searching Cell ID, using an equation as bellow,
$$θ = asin \{ E [ \frac{ln ( {P}_{C}^{l} / {P}_{C}^{l - 1} )}{- j 2 π d / λ} ] \}$$
where, PIc denotes an inter-correlation value of a received signal and a preamble signal of the cell ID from an Ith antenna, d denotes a distance between the antennas and λ denotes a wavelength.

25. A transceiver for a mobile/fixed relay with multiple antennas of claim 23, wherein the estimator of the peak searching method is to search a θ value at which the product of the adjusting vectors becomes a maximum, while completing searching the cell ID, using an equation as below,
$$θ = {max}_{θ} ( {a ( θ )}^{H} {P}_{C} )$$
where Pc denotes an inter-correlation value to a received signal and a preamble signal of the cell ID, and a(θ) denotes the adjusting vector.

26. A transceiver for a mobile/fixed relay with multiple antennas of claim 23, wherein the estimator of the joint peak searching method is to search the cell ID and the incidence angle at which the product of the adjusting vector becomes a maximum after evaluating the inter-correlation with the received signal for possible cell ID, using an equation as below,
$$( C , θ ) = {max}_{c , θ} ( {a ( θ )}^{H} {P}_{c} )$$
where P denotes a correlation vector of a received signal and a preamble signal of the cell ID, and a(θ) denotes a adjusting vector.

27. A method of transceiving for a mobile/fixed relay with multiple antennas able to improve a performance of a mobile communication system in TDD communication system, which comprises:
receiving signals of each mobile communication systems for downward link signals using a beam-forming antenna and a diversity antenna;
separating the received signals into each mobile communication system signals, converting them into base-band signals, and estimating and compensating a synchronization;
performing a cell searching for searching a target base station using the base-band signals;
estimating a channel after the cell searching;
measuring a channel correlation between the beam-forming antennas from the estimated signals of the channel, measuring a channel rank between the beam-forming antennas, and measuring a signal ratio of the target base station to the interference base station;
detecting a signal, using a mobile relay beam-former for hard handover when the channel correlation value is larger than a reference channel correlation value, or the channel rank value is smaller than a reference channel rank value, and using a MRC when the channel correlation value is smaller than a reference channel correlation value, or the channel rank value is larger than a reference channel rank value and the value measured by the signal to interference ratio is larger than that of a reference signal to interference ratio, or using an interference canceller when the channel correlation value is smaller than a reference channel correlation value, or the channel rank value is larger than a reference channel rank value, and when the value measured by the signal to interference ratio is smaller than that of a reference signal to interference ratio;
demodulating and modulating the detected signals;
converting the modulating signals into analogue signals; and
transmitting the converted signals to an inner terminal.

28. A method of transceiving for a mobile/fixed relay with multiple antennas able to improve a performance of a wireless communication system in TDD communication system, which comprises:
receiving signals of each wireless communication systems for upward link signals using a beam-forming antenna and a diversity antenna;
separating the received signals into each communication system signals and converting them into base-band signals of digital type;
equalizing a channel from the signals converted into the digital signals;
demodulating and modulating the signals undergoing the equalization process;
selecting from the converted signals whether using a mobile/fixed relay beam-former for hard handover and a MRT or an interference canceller, and coding modulated signals through any one selected from the mobile/fixed relay beam-former for hard handover, MRT and the interference canceller;
converting the coded signals into analogue signals; and
converting the signals converted into the analogue signals into pass-band signals to transmit them to a base station.

29. A method of transceiving for a mobile/fixed relay with multiple antennas able to improve a performance of a mobile communication system in FDD communication system, which comprises:
receiving signals of each mobile communication systems for downward link signal using a beam-forming antenna and a diversity antenna;
separating the received signals into each mobile communication system signals, converting them into base-band signals, and estimating and compensating a synchronization;
performing a cell searching for searching a target base station from the signals undergoing the synchronization process;
forming a beam for soft handover from the signals undergoing the cell searching process;
estimating a channel from the beam-formed signals and equalizing the estimated signals;
demodulating and modulating the equalized signals; and
converting the modulated signals into analogue signals to transmit them to an inner terminal.

30. A method of transceiving for a mobile/fixed relay with multiple antennas able to improve a performance of a mobile communication system in FDD communication system, which comprises:
receiving signals of each mobile communication systems for upward link signal using a beam-forming antenna and a diversity antenna;
separating the received signals into each mobile communication system signals, and converting them into base-band signals;
channel-equalizing the converted signals converted into the digital signals, and demodulating and modulating thereof;
pre-coding the modulated signals;
converting the pre-coded signals into analogue signals;
converting the signals converted into the analogue signals into pass-band signals; and
transmitting the signals converted into the pass-band signals to a base station.

31. A method of transceiving for a mobile/fixed relay with multiple antennas able to improve a performance of a wireless communication system in broadcasting communication system, which comprises:
receiving signals of each wireless communication systems using a beam-forming antenna and a diversity antenna;
separating the signals received from an outer receiving antenna into each wireless communication system signals and converting them into base-band signals;
estimating and compensating a synchronization from the signals converted into the digital signals;
estimating a channel from the signals undergoing the synchronization process;
detecting a signal after the channel estimating process;
demodulating and modulating from the detected signals; and
converting the modulated signals into analog signals to transmit them to an inner terminal.

32. A method of transceiving for a mobile/fixed relay with multiple antennas of claim 27, wherein the channel correlation measurement estimates a signal received from the circular array antenna using a math equation as bellow,
$$\begin{matrix}ρ = 〈 {y}_{n} , {y}_{m} 〉 \\ = \frac{E [ {y}_{n} {y}_{m} ] - E [ {y}_{n} ] E [ {y}_{m} ]}{\sqrt{( E [ {y}_{n}^{2} ] - {E [ {y}_{n} ]}^{2} ) ( E [ {y}_{m}^{2} ] - {E [ {y}_{m} ]}^{2} )}}\end{matrix}$$
where yn is a signal received in nth antenna, ym is a signal received in mth antenna, and E[ ] denotes an average.

33. A method of transceiving for a mobile/fixed relay with multiple antennas of claim 27, wherein the channel correlation measurement employs a circular array antenna and estimates a channel correlation between the antennas using a math equation as bellow,
$$\begin{matrix}ρ = 〈 {H}_{n} , {H}_{m} 〉 \\ = \frac{E [ {H}_{n} {H}_{m} ] - E [ {H}_{n} ] E [ {H}_{m} ]}{\sqrt{( E [ {H}_{n}^{2} ] - {E [ {H}_{n} ]}^{2} ) ( E [ {H}_{m}^{2} ] - {E [ {H}_{m} ]}^{2} )}}\end{matrix}$$
where Hn is a channel input through nth antenna, Hm is a channel input through mth antenna, and E[ ] denotes an average.

34. A method of transceiving for a mobile/fixed relay with multiple antennas of claim 8, wherein the channel rank measurement using a channel value employs a circular array antenna and measures a channel rank between the antennas using a math equation as bellow,
det(Hₘₙ−λIₘₙ)=0
where Hnm denotes a channel input through an antenna, m denotes an antenna and n denotes a tap or a sub-carrier of a channel.

35. A method of transceiving for a mobile/fixed relay with multiple antennas of claim 8, wherein the signal to interference ratio measurement estimates the ratio of a signal of a target base station to a signal of a adjacent base station acting as an interference, using a math equation as bellow,
$$• SIR = 10 {log}_{10} \{ \frac{{\sum }_{i = 0}^{N} y ( {N}_{Spacing} \times i + {N}_{offset} + {S}_{T} ) \times {P}_{T} ( i )}{{\sum }_{k = 0}^{N} \{ {\sum }_{i = 0}^{N} y ( {N}_{Spacing} \times i + {N}_{offset} + {S}_{k} ) \times {P}_{k} ( i ) \}} \}$$
where y denotes a received signal, PT denotes a preamble of a target signal, Pk denotes a preamble of kth interference signal, NSpacing denotes an interval between the frequencies of a preamble signal, NInt1 denotes the number of an interference signal, Np denotes the number of preamble sub-carrier wave, Noffset denotes an sub-carrier offset of preamble, ST denotes a segment of a target signal, and Sk denotes a segment of kth interference signal.

36. A method of transceiving for a mobile/fixed relay with multiple antennas of claim 8, wherein the cell searching performs a searching an incidence angle and a cell, using a math equation as bellow,
$$( C , θ ) = {max}_{c , θ} ( {a ( θ )}^{H} {R}_{c} a ( θ ) )$$
$$( C , θ ) = {max}_{c , θ} ( \frac{1}{{a ( θ )}^{H} {R}_{c}^{- 1} a ( θ )} )$$
$$( C , θ ) = {max}_{c , θ} ( \frac{1}{{a ( θ )}^{H} {( {V}_{c} )}_{n} {( {V}_{c} )}_{n}^{H} a ( θ )} )$$
where Rc denotes a self-correlation vector in an inter-correlation matrix of a preamble and a received signal, a(θ) denotes a adjusting vector for an incidence angle θ, (Vc)n denotes a noise sub-space vector, and C becomes Cell ID(C) and θ becomes an incidence angle when each of the above equations becomes maximum.

37. A method of transceiving for a mobile/fixed relay with multiple antennas of claim 21, wherein some candidate of incidence angles is estimated from the received signals prior to estimation of Cell ID and incidence angle only for the candidate of the incidence angle, and wherein the candidate of the incidence angle is estimated in a first step,
$$P ( θ ) = {max}_{θ} ( {a ( θ )}^{H} Ra ( θ ) )$$
$$P ( θ ) = {max}_{θ} ( \frac{1}{{a ( θ )}^{H} {R}^{- 1} a ( θ )} )$$
$$P ( θ ) = {max}_{θ} ( \frac{1}{{a ( θ )}^{H} {V}_{n} {V}_{n}^{H} a ( θ )} )$$
where R denotes a self-correlation matrix for a received signal, a(θ) denotes a adjusting vector for an incidence angle θ, M (M is a natural number) of θ value becomes the candidate of the incidence angle in each equations, and the cell ID & incidence angle are estimated in a second step using the candidate of the incidence angle,
$$( C , θ ) = {max}_{c , θ} ( {a ( {θ}_{m} )}^{H} {P}_{c} ) , m = 0 , 1 , ⋯ , M - 1$$
where, θm means the candidate of the incidence angle estimated from the first step, M denotes the number of the candidate of the incidence angle, and the cell searching and the incidence angle is simultaneously estimated using the above equation.

38. A method of transceiving for a mobile/fixed relay with multiple antennas of claim 21, wherein direct searching, peak searching and joint peak searching method are used in simultaneously estimating the cell searching and the incidence angle which can estimate the cell ID & the incidence angle, using the inter-correlation matrix of the preamble and the received signals.

39. A method of transceiving for a mobile/fixed relay with multiple antennas of claim 23, wherein the direct searching method is to search a θ value at which the product of the adjusting vectors becomes a maximum, while completing searching Cell ID, using an equation as bellow,
$$θ = asin \{ E [ \frac{ln ( {P}_{C}^{l} / {P}_{C}^{l - 1} )}{- j2π d / λ} ] \}$$
where, PIc denotes an inter-correlation value of a received signal and a preamble signal of the cell ID from an Ith antenna, d denotes a distance between the antennas and λ denotes a wavelength.

40. A method of transceiving for a mobile/fixed relay with multiple antennas of claim 23, wherein the peak searching method is to search a θ value at which the product of the adjusting vectors becomes a maximum, while completing searching the cell ID, using an equation as below,
$$θ = {max}_{θ} ( {a ( θ )}^{H} {P}_{C} )$$
where Pc denotes an inter-correlation value to a received signal and a preamble signal of the cell ID, and a(θ) denotes the adjusting vector.

41. A method of transceiving for a mobile/fixed relay with multiple antennas of claim 23, wherein the joint peak searching method is to search the cell ID and the incidence angle at which the product of the adjusting vector becomes a maximum after evaluating the inter-correlation with the received signal for possible cell ID, using an equation as below,
$$( C , θ ) = {max}_{c , θ} ( {a ( θ )}^{H} {P}_{c} )$$
where P denotes a correlation vector of a received signal and a preamble signal of the cell ID, and a(θ) denotes a adjusting vector.

42. A method of transceiving for a mobile/fixed relay with multiple antennas of claim 27, wherein SRB beam-forming is used in the mobile relay beam-former for hard handover.

43. A method of transceiving for a mobile/fixed relay with multiple antennas of claim 27, wherein TRB beam-forming is used in the beam-forming for hard handover.

44. A method of transceiving for a mobile/fixed relay with multiple antennas of claim 27, wherein simultaneous cell searching and incidence angle is performed when estimating the incidence angle for a mobile relay beam-forming for hard handover.

45. A method of transceiving for a mobile/fixed relay with multiple antennas of claim 29, wherein SRB beam-forming is used in the beam-forming for soft handover.

46. A method of transceiving for a mobile/fixed relay with multiple antennas of claim 29, wherein the beam-forming for soft handover forms a beam toward both the target base station and the adjacent base station to combine the two signals.

47. A transceiver for a mobile/fixed relay with multiple antennas of claim 9, wherein when a beam-former is selected, a circular array antenna which is the beam-former is used.

48. A transceiver for a mobile/fixed relay with multiple antennas of claim 10, wherein when a beam-former is selected, a circular array antenna which is the beam-former is used.

49. A transceiver for a mobile/fixed relay with multiple antennas of claim 11, wherein when a beam-former is selected, a circular array antenna which is the beam-former is used.

50. A transceiver for a mobile/fixed relay with multiple antennas of claim 12, wherein the MRC employs a signal of the diversity antenna.

51. A transceiver for a mobile/fixed relay with multiple antennas of claim 9, wherein the interference canceller employs a signal of the diversity antenna.

52. A transceiver for a mobile/fixed relay with multiple antennas of claim 10, wherein the cell searcher performs a searching an incidence angle and a cell, using a math equation as bellow,
$$( C , θ ) = {max}_{c , θ} ( {a ( θ )}^{H} {R}_{c} a ( θ ) )$$
$$( C , θ ) = {max}_{c , θ} ( \frac{1}{{a ( θ )}^{H} {R}_{c}^{- 1} a ( θ )} )$$
$$( C , θ ) = {max}_{c , θ} ( \frac{1}{{a ( θ )}^{H} {( {V}_{c} )}_{n} {( {V}_{c} )}_{n}^{H} a ( θ )} )$$
where Rc denotes a self-correlation vector in an inter-correlation matrix of a preamble and a received signal, a(θ) denotes a adjusting vector for an incidence angle θ, (Vc)n denotes a noise sub-space vector, and C becomes Cell ID(C) and θ becomes an incidence angle when each of the above equations becomes maximum.

53. A method of transceiving for a mobile/fixed relay with multiple antennas of claim 10, wherein the cell searching performs a searching an incidence angle and a cell, using a math equation as bellow,
$$( C , θ ) = {max}_{c , θ} ( {a ( θ )}^{H} {R}_{c} a ( θ ) )$$
$$( C , θ ) = {max}_{c , θ} ( \frac{1}{{a ( θ )}^{H} {R}_{c}^{- 1} a ( θ )} )$$
$$( C , θ ) = {max}_{c , θ} ( \frac{1}{{a ( θ )}^{H} {( {V}_{c} )}_{n} {( {V}_{c} )}_{n}^{H} a ( θ )} )$$
where Rc denotes a self-correlation vector in an inter-correlation matrix of a preamble and a received signal, a(θ) denotes a adjusting vector for an incidence angle θ, (Vc)n denotes a noise sub-space vector, and C becomes Cell ID(C) and θ becomes an incidence angle when each of the above equations becomes maximum.

54. A method of transceiving for a mobile/fixed relay with multiple antennas of claim 28, wherein SRB beam-forming is used in the mobile relay beam-former for hard handover.

55. A method of transceiving for a mobile/fixed relay with multiple antennas of claim 28, wherein TRB beam-forming is used in the beam-forming for hard handover.

56. A method of transceiving for a mobile/fixed relay with multiple antennas of claim 28, wherein simultaneous cell searching and incidence angle is performed when estimating the incidence angle for a mobile relay beam-forming for hard handover.
